(19) United States
(12) Patent Application Publication
(10) Pub. No.: US 2026/0205848 A1
(43) Pub. Date: Jul. 16, 2026

(54) CELL SELECTION IN WIRELESS COMMUNICATIONS SYSTEMS

(71) Applicant: QUALCOMM Incorporated, San Diego, CA (US)

(72) Inventors: Kiran VENUGOPAL, Green Brook, NJ (US); Yan ZHOU, San Diego, CA (US); Jing JIANG, San Diego, CA (US)

(21) Appl. No.: 19/022,989

(22) Filed: Jan. 15, 2025

(51) Int. Cl. H04W 24/10; H04W 52/24

(52) U.S. Cl. CPC H04W 24/10; H04W 52/242

(57) ABSTRACT

Methods, systems, and devices for wireless communications are described. A user equipment (UE) may receive control signaling that identifies a set of candidate cells associated with a mobility procedure at the UE, where the control signaling indicates a quality metric associated with a first communication link between the UE and the set of candidate cells. The UE may additionally obtain, for one or more candidate cells of the set of candidate cells, a respective first measurement corresponding to the first communication link and a respective second measurement corresponding to a second communication link between the UE and the set of candidate cells. Accordingly, the UE may transmit a mobility report that indicates a subset of candidate cells of the set of candidate cells in accordance with obtaining the control signaling, where the respective first measurement of each candidate cell of the subset of candidate cells satisfies the quality metric.

### FIELD OF TECHNOLOGY

The following relates to wireless communications, including cell selection in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that identifies a set of candidate cells associated with a mobility procedure at the UE, where the control signaling indicates a quality metric associated with a first communication link between the UE and the set of candidate cells, obtaining, for one or more candidate cells of the set of candidate cells, a respective first measurement corresponding to the first communication link and a respective second measurement corresponding to a second communication link between the UE and the set of candidate cells, and transmitting a mobility report that indicates a subset of candidate cells of the set of candidate cells in accordance with the obtaining, where the respective first measurement of each candidate cell of the subset of candidate cells satisfies the quality metric.

A UE for wireless communications is described. The UE may include one or more memories storing processor executable code, and one or more processors coupled with the one or more memories. The one or more processors may individually or collectively be operable to execute the code to cause the UE to receive control signaling that identifies a set of candidate cells associated with a mobility procedure at the UE, where the control signaling indicates a quality metric associated with a first communication link between the UE and the set of candidate cells, obtain, for one or more candidate cells of the set of candidate cells, a respective first measurement corresponding to the first communication link and a respective second measurement corresponding to a second communication link between the UE and the set of candidate cells, and transmit a mobility report that indicates a subset of candidate cells of the set of candidate cells in accordance with the obtaining, where the respective first measurement of each candidate cell of the subset of candidate cells satisfies the quality metric.

Another UE for wireless communications is described. The UE may include means for receiving control signaling that identifies a set of candidate cells associated with a mobility procedure at the UE, where the control signaling indicates a quality metric associated with a first communication link between the UE and the set of candidate cells, means for obtaining, for one or more candidate cells of the set of candidate cells, a respective first measurement corresponding to the first communication link and a respective second measurement corresponding to a second communication link between the UE and the set of candidate cells, and means for transmitting a mobility report that indicates a subset of candidate cells of the set of candidate cells in accordance with the obtaining, where the respective first measurement of each candidate cell of the subset of candidate cells satisfies the quality metric.

A non-transitory computer-readable medium storing code for wireless communications is described. The code may include instructions executable by one or more processors to receive control signaling that identifies a set of candidate cells associated with a mobility procedure at the UE, where the control signaling indicates a quality metric associated with a first communication link between the UE and the set of candidate cells, obtain, for one or more candidate cells of the set of candidate cells, a respective first measurement corresponding to the first communication link and a respective second measurement corresponding to a second communication link between the UE and the set of candidate cells, and transmit a mobility report that indicates a subset of candidate cells of the set of candidate cells in accordance with the obtaining, where the respective first measurement of each candidate cell of the subset of candidate cells satisfies the quality metric.

In some examples of the method, UEs, and non-transitory computer-readable medium described herein, performing the mobility procedure may include operations, features, means, or instructions for communicating, for the first communication link and the second communication link, with a first candidate cell identified from the subset of candidate cells in accordance with transmitting the mobility report.

In some examples of the method, UEs, and non-transitory computer-readable medium described herein, the control signaling further indicates a respective priority for measuring the second communication link for each candidate cell of the set of candidate cells and the method, apparatuses, and non-transitory computer-readable medium may include further operations, features, means, or instructions for obtaining the respective first measurement and the respective second measurement of the one or more candidate cells according to an order that may be in accordance with the respective priority of each candidate cell of the set of candidate cells.

In some examples of the method, UEs, and non-transitory computer-readable medium described herein, the obtaining may include operations, features, means, or instructions for receiving, via the second communication link, a first reference signal from a first candidate cell of the set of candidate cells, where the first reference signal corresponds to a second reference signal associated with the first communication link, obtaining the respective second measurement of the first candidate cell in accordance with measuring the first reference signal, and deriving the respective first measurement associated with the first candidate cell in accordance with the respective second measurement, a transmission power of the UE, an offset, or any combination thereof.

In some examples of the method, UEs, and non-transitory computer-readable medium described herein, the obtaining may include operations, features, means, or instructions for receiving, via the second communication link, a path loss reference signal from a first candidate cell of the set of candidate cells, obtaining a path loss of the second communication link in accordance with measuring the path loss reference signal, and deriving the respective first measurement associated with the first candidate cell in accordance with a transmission power of the UE and the path loss of the second communication link.

In some examples of the method, UEs, and non-transitory computer-readable medium described herein, the control signaling further indicates a rule for combining the respective first measurement with the respective second measurement and the method, apparatuses, and non-transitory computer-readable medium may include further operations, features, means, or instructions for obtaining, for each candidate cell, a respective composite measurement in accordance with a combination of the respective first measurement and the respective second measurement according to the rule, where an order of the subset of candidate cells in the mobility report may be in accordance with the respective composite measurement of each candidate cell of the set of candidate cells.

In some examples of the method, UEs, and non-transitory computer-readable medium described herein, the control signaling further indicates a first scaling factor associated with the first communication link and a second scaling factor associated with the second communication link and the method, apparatuses, and non-transitory computer-readable medium may include further operations, features, means, or instructions for obtaining a respective adjusted first measurement in accordance with an application of the first scaling factor to each respective first measurement and obtaining a respective adjusted second measurement in accordance with an application of the second scaling factor to each respective second measurement, where the respective adjusted first measurement of each candidate cell of the subset of candidate cells satisfies the quality metric, and where the respective adjusted second measurement of each candidate cell of the subset of candidate cells satisfies a second quality metric.

In some examples of the method, UEs, and non-transitory computer-readable medium described herein, the control signaling further indicates a second quality metric associated with the second communication link for each candidate cell of the set of candidate cells and the respective second measurement of each candidate cell of the subset of candidate cells satisfies the second quality metric.

In some examples of the method, UEs, and non-transitory computer-readable medium described herein, the control signaling further indicates a threshold quantity of candidate cells to be reported and a quantity of the subset of candidate cells satisfies the threshold quantity of candidate cells.

In some examples of the method, UEs, and non-transitory computer-readable medium described herein, the first communication link includes an uplink, and the second communication link includes a downlink, and the first communication link includes the downlink and the second communication link includes the uplink.

A method for wireless communications by a UE is described. The method may include receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells, obtaining a respective first measurement associated with the first communication link for the first set of candidate cells in accordance with the respective first priorities, obtaining a respective second measurement associated with the second communication link for the second set of candidate cells in accordance with the respective second priorities, and transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

A UE for wireless communications is described. The UE may include one or more memories storing processor executable code, and one or more processors coupled with the one or more memories. The one or more processors may individually or collectively be operable to execute the code to cause the UE to receive control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells, obtain a respective first measurement associated with the first communication link for the first set of candidate cells in accordance with the respective first priorities, obtain a respective second measurement associated with the second communication link for the second set of candidate cells in accordance with the respective second priorities, and transmit a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

Another UE for wireless communications is described. The UE may include means for receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells, means for obtaining a respective first measurement associated with the first communication link for the first set of candidate cells in accordance with the respective first priorities, means for obtaining a respective second measurement associated with the second communication link for the second set of candidate cells in accordance with the respective second priorities, and means for transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

A non-transitory computer-readable medium storing code for wireless communications is described. The code may include instructions executable by one or more processors to receive control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells, obtain a respective first measurement associated with the first communication link for the first set of candidate cells in accordance with the respective first priorities, obtain a respective second measurement associated with the second communication link for the second set of candidate cells in accordance with the respective second priorities, and transmit a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

In some examples of the method, UEs, and non-transitory computer-readable medium described herein, performing the mobility procedure may include operations, features, means, or instructions for communicating, for the first communication link, with a first candidate cell identified from the first subset of candidate cells in accordance with transmitting the mobility report and communicating, for the second communication link, with a second candidate cell identified from the second subset of candidate cells in accordance with transmitting the mobility report.

In some examples of the method, UEs, and non-transitory computer-readable medium described herein, the control signaling includes a list indicating the first set of candidate cells and the method, apparatuses, and non-transitory computer-readable medium may include further operations, features, means, or instructions for determining the respective first priorities for each candidate cell of the first set of candidate cells in accordance with an order of a respective index of each candidate cell of the first set of candidate cells within the list.

In some examples of the method, UEs, and non-transitory computer-readable medium described herein, the control signaling includes a list indicating the second set of candidate cells and the method, apparatuses, and non-transitory computer-readable medium may include further operations, features, means, or instructions for determining the respective second priorities for each candidate cell of the second set of candidate cells in accordance with an order of a respective index of each candidate cell of the second set of candidate cells within the list.

In some examples of the method, UEs, and non-transitory computer-readable medium described herein, and the method, apparatuses, and non-transitory computer-readable medium may include further operations, features, means, or instructions for determining the respective first priorities for each candidate cell of the first set of candidate cells in accordance with the respective identifiers.

In some examples of the method, UEs, and non-transitory computer-readable medium described herein, and the method, apparatuses, and non-transitory computer-readable medium may include further operations, features, means, or instructions for determining the respective second priorities for each candidate cell of the second set of candidate cells in accordance with the respective identifiers.

In some examples of the method, UEs, and non-transitory computer-readable medium described herein, the control signaling indicates a first scaling factor associated with the first communication link and a second scaling factor associated with the second communication link and the method, apparatuses, and non-transitory computer-readable medium may include further operations, features, means, or instructions for obtaining a respective adjusted first measurement in accordance with an application of the first scaling factor to each respective first measurement and obtaining a respective adjusted second measurement in accordance with an application of the second scaling factor to each respective second measurement, where the respective adjusted first measurement of each candidate cell of the first subset of candidate cells satisfies a first quality metric, and where the respective adjusted second measurement of each candidate cell of the second subset of candidate cells satisfies a second quality metric.

In some examples of the method, UEs, and non-transitory computer-readable medium described herein, the control signaling includes a flag that indicates whether the UE may implicitly determine the respective first priorities and implicitly determine the respective second priorities.

In some examples of the method, UEs, and non-transitory computer-readable medium described herein, the first set of candidate cells and the second set of candidate cells may be equivalent and the control signaling includes a flag that indicates the respective first priorities and the respective second priorities may be equivalent.

In some examples of the method, UEs, and non-transitory computer-readable medium described herein, the control signaling further indicates a first quality metric associated with the first communication link and a second quality metric associated with the second communication link, the respective first measurement for each candidate cell of the first subset of candidate cells satisfies the first quality metric, and the respective second measurement for each candidate cell of the second subset of candidate cells satisfies the second quality metric.

A method for wireless communications by a UE is described. The method may include receiving control signaling that indicates a set of candidate cells associated with a mobility procedure at the UE, where the control signaling identifies a respective set of parameters associated with measurements of a first communication link for each candidate cell of the set of candidate cells, obtaining respective first measurements associated with the first communication link for each candidate cell of the set of candidate cells according to the respective sets of parameters, obtaining respective second measurements associated with a second communication link for each candidate cell of the set of candidate cells in accordance with the control signaling, and transmitting a mobility report that indicates a subset of candidate cells of the set of candidate cells and indicates at least the respective first measurements associated with one or more candidate cells of the subset of candidate cells.

A UE for wireless communications is described. The UE may include one or more memories storing processor executable code, and one or more processors coupled with the one or more memories. The one or more processors may individually or collectively be operable to execute the code to cause the UE to receive control signaling that indicates a set of candidate cells associated with a mobility procedure at the UE, where the control signaling identifies a respective set of parameters associated with measurements of a first communication link for each candidate cell of the set of candidate cells, obtain respective first measurements associated with the first communication link for each candidate cell of the set of candidate cells according to the respective sets of parameters, obtain respective second measurements associated with a second communication link for each candidate cell of the set of candidate cells in accordance with the control signaling, and transmit a mobility report that indicates a subset of candidate cells of the set of candidate cells and indicates at least the respective first measurements associated with one or more candidate cells of the subset of candidate cells.

Another UE for wireless communications is described. The UE may include means for receiving control signaling that indicates a set of candidate cells associated with a mobility procedure at the UE, where the control signaling identifies a respective set of parameters associated with measurements of a first communication link for each candidate cell of the set of candidate cells, means for obtaining respective first measurements associated with the first communication link for each candidate cell of the set of candidate cells according to the respective sets of parameters, means for obtaining respective second measurements associated with a second communication link for each candidate cell of the set of candidate cells in accordance with the control signaling, and means for transmitting a mobility report that indicates a subset of candidate cells of the set of candidate cells and indicates at least the respective first measurements associated with one or more candidate cells of the subset of candidate cells.

A non-transitory computer-readable medium storing code for wireless communications is described. The code may include instructions executable by one or more processors to receive control signaling that indicates a set of candidate cells associated with a mobility procedure at the UE, where the control signaling identifies a respective set of parameters associated with measurements of a first communication link for each candidate cell of the set of candidate cells, obtain respective first measurements associated with the first communication link for each candidate cell of the set of candidate cells according to the respective sets of parameters, obtain respective second measurements associated with a second communication link for each candidate cell of the set of candidate cells in accordance with the control signaling, and transmit a mobility report that indicates a subset of candidate cells of the set of candidate cells and indicates at least the respective first measurements associated with one or more candidate cells of the subset of candidate cells.

In some examples of the method, UEs, and non-transitory computer-readable medium described herein, the obtaining may include operations, features, means, or instructions for receiving, via the second communication link, a first reference signal from a first candidate cell of the set of candidate cells, where the first reference signal corresponds to a second reference signal associated with the first communication link, obtaining the respective second measurements of the first candidate cell in accordance with measuring the first reference signal, and deriving the respective first measurements associated with the first candidate cell in accordance with the respective second measurements, a transmission power of the UE, an offset, or any combination thereof, where the respective set of parameters associated with the first candidate cell includes the offset.

In some examples of the method, UEs, and non-transitory computer-readable medium described herein, the obtaining may include operations, features, means, or instructions for receiving, via the second communication link, a path loss reference signal from a first candidate cell of the set of candidate cells, obtaining a path loss of the second communication link in accordance with measuring the path loss reference signal, and deriving the respective first measurements associated with the first candidate cell in accordance with a transmission power of the UE and the path loss of the second communication link.

In some examples of the method, UEs, and non-transitory computer-readable medium described herein, transmitting the mobility report may include operations, features, means, or instructions for transmitting, via the mobility report, an indication of a respective set of beams per candidate cell of the subset of candidate cells and an indication of a respective first measurement for each beam of the respective set of beams per candidate cell, where a quantity of the subset of candidate cells satisfies the threshold quantity of candidate cells, and where a quantity of beams of the respective set of beams per candidate cell satisfies the threshold quantity of beams.

In some examples of the method, UEs, and non-transitory computer-readable medium described herein, transmitting the mobility report may include operations, features, means, or instructions for transmitting, via the mobility report, an indication of a respective set of beams per candidate cell of a first subset of candidate cells and an indication of a respective first measurement for each beam of the respective set of beams per candidate cell of the first subset of candidate cells, where a quantity of the first subset of candidate cells satisfies the first threshold quantity of candidate cells and transmitting, via the mobility report, an indication of a respective set of beams per candidate cell of a second subset of candidate cells and an indication of a respective second measurement for each beam of the respective set of beams per candidate cell of the second subset of candidate cells, where a quantity of the second subset of candidate cells satisfies the second threshold quantity of candidate cells.

In some examples of the method, UEs, and non-transitory computer-readable medium described herein, transmitting the mobility report may include operations, features, means, or instructions for transmitting, via the mobility report, an indication of a respective set of beams per candidate cell of the subset of candidate cells, an indication of a respective first measurement for each beam of the respective set of beams per candidate cell of the subset of candidate cells, and an indication of a respective second measurement for each beam of the respective set of beams per candidate cell of the subset of candidate cells, where a quantity of the subset of candidate cells satisfies the threshold quantity of candidate cells.

In some examples of the method, UEs, and non-transitory computer-readable medium described herein, transmitting the mobility report may include operations, features, means, or instructions for transmitting, via the mobility report, an indication of a respective set of beams per candidate cell of the subset of candidate cells, an indication of a respective first measurement for each beam of a first subset of beams of each respective set of beams, and an indication of a respective second measurement for each beam of a second subset of beams of each respective set of beams, where a quantity of the subset of candidate cells satisfies the threshold quantity of candidate cells.

In some examples of the method, UEs, and non-transitory computer-readable medium described herein, transmitting the mobility report may include operations, features, means, or instructions for transmitting, via the mobility report and for a first candidate cell, a first set of beams and a respective first measurement for each beam of the first set of beams in accordance with the control signaling and transmitting, via the mobility report and for a second candidate cell, a second set of beams and a respective second measurement for each beam of the second set of beams in accordance with the control signaling.

In some examples of the method, UEs, and non-transitory computer-readable medium described herein, the respective set of parameters for each candidate cell of the set of candidate cells includes a respective bandwidth, a respective transmission power, a respective pathloss, respective traffic load information, respective traffic utilization, respective quantity of active communication links, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports cell selection in wireless communications systems in accordance with one or more aspects of the present disclosure.

FIG. 2 shows an example of a wireless communications system that supports cell selection in wireless communications systems in accordance with one or more aspects of the present disclosure.

FIG. 3 shows an example of a wireless communications system that supports cell selection in wireless communications systems in accordance with one or more aspects of the present disclosure.

FIG. 4 shows an example of a process flow that supports cell selection in wireless communications systems in accordance with one or more aspects of the present disclosure.

FIG. 5 shows an example of a wireless communications system that supports cell selection in wireless communications systems in accordance with one or more aspects of the present disclosure.

FIG. 6 shows an example of a process flow that supports cell selection in wireless communications systems in accordance with one or more aspects of the present disclosure.

FIGS. 7A through 7E show examples of report formats that support cell selection in wireless communications systems in accordance with one or more aspects of the present disclosure.

FIG. 8 shows an example of a process flow that supports cell selection in wireless communications systems in accordance with one or more aspects of the present disclosure.

FIGS. 9 and 10 show block diagrams of devices that support cell selection in wireless communications systems in accordance with one or more aspects of the present disclosure.

FIG. 11 shows a block diagram of a communications manager that supports cell selection in wireless communications systems in accordance with one or more aspects of the present disclosure.

FIG. 12 shows a diagram of a system including a device that supports cell selection in wireless communications systems in accordance with one or more aspects of the present disclosure.

FIGS. 13 through 18 show flowcharts illustrating methods that support cell selection in wireless communications systems in accordance with one or more aspects of the present disclosure.

### DETAILED DESCRIPTION

In some wireless communications systems, a user equipment (UE) may perform mobility procedures (e.g., handover procedures) to transition from communicating via a first cell to communicating via a second cell. To facilitate such mobility, a network entity may provide the UE with a list of cells (e.g., list of candidate cells via a system information block (SIB), among other examples), such that the UE may measure one or more downlink metrics for each cell of the list. The UE may select a subset of cells from the list of cells according to the measured downlink metrics and transmit a report indicating the subset of the cells to the network entity. As such, the network entity or the UE may identify a cell from the reported subset of cells, such that the UE may transition to communicating (e.g., perform the handover) to the identified cell.

However, selecting a cell from the subset of cells that are identified according to the one or more downlink metrics may be insufficient to identify (e.g., identify and report) a cell with a sufficient uplink performance. For example, while the subset of cells reported by the UE may have sufficient quality metrics for downlink communications (e.g., because the UE selects the subset of cells according to the measured downlink metrics), such subset of cells may provide relatively poor uplink performance (e.g., compared to the downlink performance) due to various factors, such as an imbalanced transmission power, among other examples. As such, during handovers, the UE may transition to a cell that is sufficient for downlink communications but may not be suitable for uplink communications, which may lead to increased latency during uplink communications, reduced reliability during uplink communications, among other disadvantages.

The techniques, methods, and devices described herein enable a UE to report a subset of cells according to both downlink metrics and uplink metrics, which may enable the UE to identify one or more cells that are sufficient for both uplink and downlink communications.

For example, in some implementations, the UE may report a set of cells that satisfy both uplink and downlink quality thresholds, such that a cell may be identified that is sufficient for both uplink and downlink communications. In such implementations, the UE may receive control signaling that identifies a set of cells associated with a mobility procedure (e.g., handover) at the UE. The control signaling may indicate a quality metric (e.g., a quality threshold) associated with uplink communications and also indicate a priority of measurement associated with downlink communications for each cell. Accordingly, the UE may obtain (e.g., measure, calculate, determine) an uplink measurement and obtain a downlink measurement for each cell of the set according to the indicated priorities. As such, the UE may transmit a report that includes a subset of cells, where a respective uplink measurement of each cell of the subset satisfies the quality metric.

In some other implementations, the UE (or network entity) may select separate cells for uplink and downlink communications (e.g., a first cell for uplink communications, and a second cell that is different from the first cell for downlink communications). For example, the UE may receive control signaling that indicates a first set of cells associated with uplink communications and a second set of cells associated with downlink communications for a mobility procedure at the UE. In such examples, the control signaling may indicate a respective first measurement priority for each of the first set of cells and a respective second measurement priority for each of the second set of cells.

In response to receiving the control signaling, UE may obtain an uplink measurement for each cell of the first set of cells according to the respective first priorities and obtain a downlink measurement for each cell of the second set of cells according to the respective second priorities. The UE may transmit a mobility report that indicates a first subset of cells of the first set of cells according to the respective uplink measurements and indicates a second subset of cells of the second set of cells according to the respective downlink measurements.

By obtaining both uplink and downlink measurements for a set of cells, the UE and the network entity may perform a cell handover procedure such that the UE may communicate with a cell suitable for both downlink and uplink communications, which may improve communication reliability and performance compared to selecting a cell for handover based on downlink metrics. Additionally, by applying downlink priority orders and/or uplink priority orders for measurement, the UE may identify a first cell for downlink communications and a second cell for uplink communications, which may collectively improve communication reliability, communication performance, and overall coordination as compared to a single cell for both downlink and uplink communications.

Aspects of the disclosure are initially described in the context of wireless communications systems. Aspects of the disclosure are further described in the context of wireless communications systems, report formats, and process flows. Aspects of the disclosure are further illustrated by and described with reference to apparatus diagrams, system diagrams, and flowcharts that relate to cell selection in wireless communications systems.

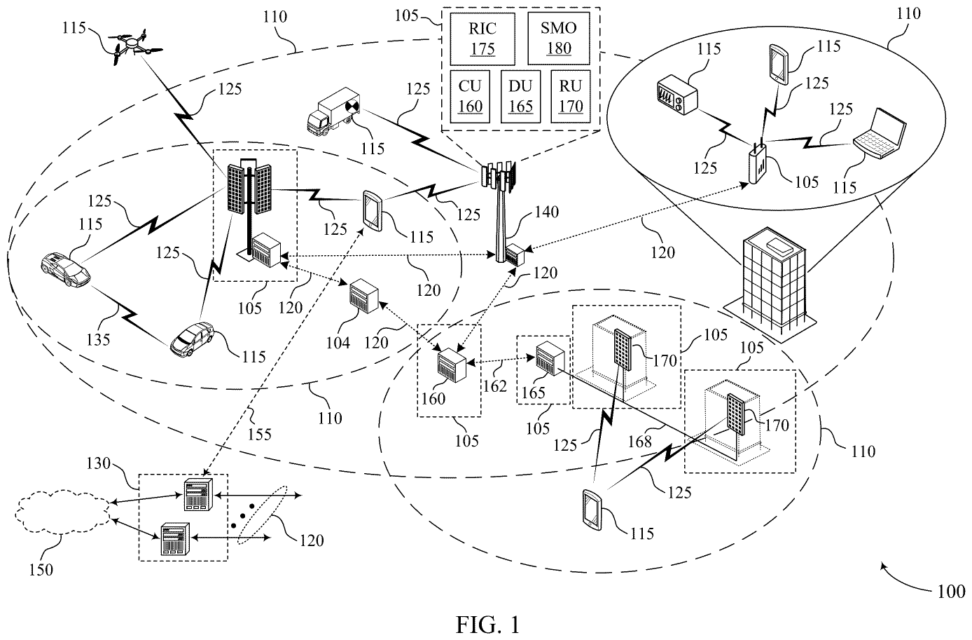

FIG. 1 shows an example of a wireless communications system 100 that supports cell selection in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support cell selection in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (bandwidthP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier (ID) for distinguishing neighboring cells (e.g., a physical cell ID (PCID), a virtual cell ID (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein may enable a UE to measure and report an uplink metric (e.g., uplink reference signal received power (RSRP)) for one or more cells (e.g., in addition to the downlink metric). For example, in some implementations, the network entity may configure the UE with a downlink priority (e.g., a beam report ranking according to the downlink metric) which is associated with an uplink quality check. In such examples, the UE may report a set of cells (e.g., based on measuring one or more beams of the set of cells) according to the downlink priority that also satisfy an uplink quality threshold (e.g., based on a configured uplink quality metric and uplink quality threshold). Additionally, or alternatively, the UE may report a set of cells according to an uplink priority. The cells (e.g., according to the uplink priority) may additionally satisfy a downlink quality threshold (e.g., based on a configured downlink metric and a configured downlink quality threshold such as downlink RSRP).

In some implementations, the UE may select separate cells for uplink and downlink communications (e.g., a first cell for uplink communications, and a second cell that is different from the first cell for downlink communications). In such implementations, the network entity may provide the UE with an uplink priority order, a downlink priority order, or both. Additionally, or alternatively, the UE may determine the uplink priority, the downlink priority order, or both based on one or more IDs associated with the cells (e.g., cells included in the neighbor cell list). In some examples, the UE may measure and select one or more cells based on the uplink priority order, the downlink priority order, or both, and the UE may report one or more respective cells according to the uplink priority order and one or more respective cells (e.g., one or more cells that are different from or are the same as the cells reported according to the uplink order) according to the downlink priority order.

In some implementations, the network entity may provide an indication of a reporting configuration to the UE. In some examples, the reporting configuration may include an indication of a quantity of cells associated with an uplink metric to report, a quantity of cells associated with a downlink metric to report, a quantity of cells associated with both an uplink and a downlink metric to report, or any combination thereof. Additionally, or alternatively, the network entity may provide the UE with an indication of measurement parameters for each cell of the set of cells that the UE may utilize to determine (e.g., measure) the uplink metric. The network entity may additionally provide the UE with an indication of a payload size and quantization to apply for the beam report (e.g., a beam report configuration).

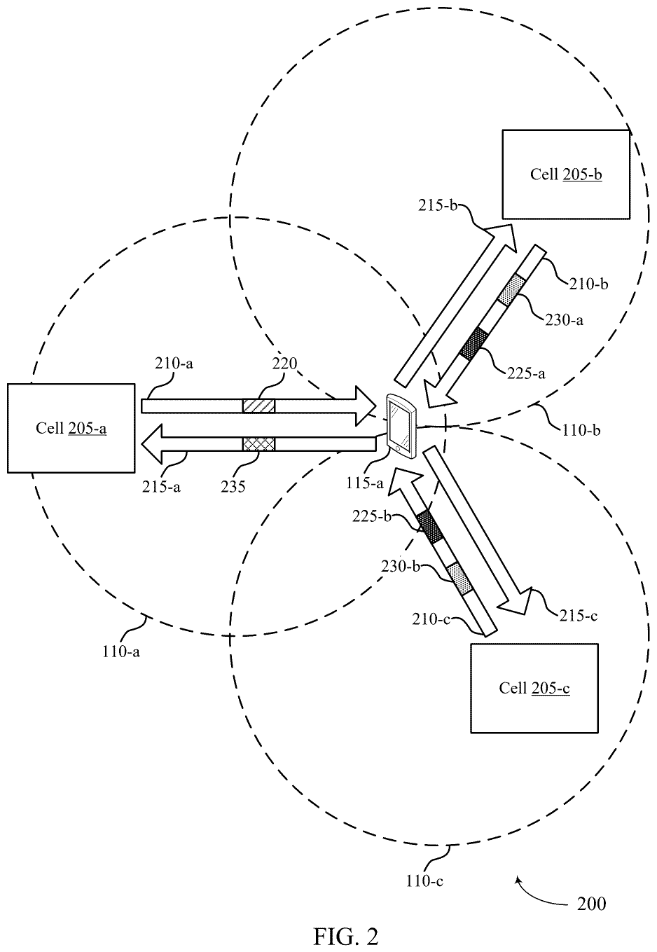

FIG. 2 shows an example of a wireless communications system 200 that supports cell selection in wireless communications systems in accordance with one or more aspects of the present disclosure. Aspects of the wireless communications system 200 may implement, or be implemented by, aspects of the wireless communications system 100. For example, the wireless communications system 200 may implement or be implemented by a UE 115-a, which may be an example of the UE 115. Additionally, the wireless communications system 200 may be implemented by one or more cells 205, such as the cells 205-a, cells 205-b, or cells 205-c. As described herein, the cells 205 may be collocated (e.g., operated and maintained by a single network entity 105) or may not be collocated (e.g., one or more cells 205 are operated by different network entities 105).

The UE 115-a may connect to the cell 205-a, such that the UE 115-a may communicate with the network (e.g., a 5G network) via the cell 205-a. In some cases, the UE 115-a may move from a coverage area 110-a of the cell 205-a into a coverage area 110-b of the cell 205-b or the coverage area 110-c of the cell 205-c. As such, the UE 115-a (or a network entity 105) may trigger a mobility procedure at the UE 115-a to transition from communicating via the cell 205-a to communicating via the cell 205-b or the cell 205-c.

To facilitate such mobility, the UE 115-a may receive, via broadcast messaging, a system information block (SIB) that includes a list of cells 205 (e.g., neighbor cell list or a list of candidate cells) for idle UE cell reselection, where list of cells 205 may be common for one or more synchronization signal blocks (SSBs). In such examples, the UE 115-a may receive a SIB3 message indicating a list of intra-frequency cells 205 (e.g., intra frequency neighbor cell list). The UE 115-a may also receive a SIB4 message indicating a list of inter-frequency cells (e.g., inter-frequency neighbor cell list) and receive a SIB5 message indicating a list of inter-radio access technology (RAT) cells 205. In some examples, in addition to the SIB3, SIB4, and SIB5 messages, the UE 115-a may receive a SIB2 message indicating a common configuration for intra-frequency, inter-frequency, and inter-RAT cell reselection.

Additionally, the UE 115-a may receive reselection priority information per frequency in the case of inter-frequency and inter-RAT idle UE cell reselection, where such priority information may have eight priority levels and four sub-priority levels. For example, the UE 115-a may receive, via a SIB message, an inter-frequency carrier information element (e.g., InterFreqCarrierFreqInfo) that indicates a downlink carrier frequency information element (e.g., dl-CarrierFreq), a cell reselection priority information element (e.g., cellReselectionPriority), and a cell reselection sub-priority information element (e.g., cellReselectionSubPriority). Further, the UE 115-a may receive, via a SIB message, a carrier frequency EUTRA information element (e.g., CarrierFreqEUTRA) that indicates a carrier frequency information element (e.g., carrierFreq), a cell reselection priority information element (e.g., cellReselectionPriority), and a cell reselection sub-priority information element (e.g., cellReselectionSubPriority).

In some cases, the network entity 105 may indicate (e.g., provide) a cell reselection priority (e.g., priority per frequency) for inter-RAT idle UE cell reselection. For example, a reselection priority may include one or more priority levels, one or more sub-priority levels, or both (e.g., eight priority levels and four sub-priority levels, among other examples). In such cases, the cell reselection priority may enable the UE 115-a to order (e.g., rank) the different cells 205 for reselection based on the downlink metric and according to the reselection priority (e.g., the UE 115-a may indicate the different cells 205 within a mobility report preferentially based on the downlink metric and reselection priority).

In some cases, for lower-layer triggered mobility (LTM) procedures, a network entity (e.g., the network entity 105, among other examples) may configure the UE 115-a to measure different handover cells 205 (e.g., a cell 205-a, a cell 205-b, or a cell 205-c, among other examples), which may be at different frequencies (e.g., serving cells having different carrier frequencies). Accordingly, the UE 115-a may transmit a cell measurement report indicating the measurements for one or more beams of a cell 205.

In the cell measurement report, the UE 115-a may report up to a threshold quantity of cells 205 (e.g., L cells, where L is equal to 1, 2, 3, 4, or more cells). In some cases, the threshold quantity of cells to be reported may be based on a UE capability (e.g., a capability of the UE 115-a). Additionally, or alternatively, the UE 115-a may determine which cells to include within the cell measurement report (e.g., which cells to be reported is up to UE implementation).

In such cases, the downlink measurement may be an RSRP, such that the UE 115-a may select the beams and cells 205 to report via the cell measurement report according to the downlink RSRP. In such cases, however, because the uplink RSRP of beams of the cells 205 are not considered during the handover procedure, the UE 115-a may connect to (e.g., handover to) a cell 205 that has weaker uplink coverage relative to the downlink.

In some cases, an uplink coverage (e.g., uplink communication performance) for a cell 205 may be relatively weaker than a downlink coverage for the cell 205 due to an imbalanced transmission power, or an obstacle or blockage impeding uplink performance, among other examples. For example, a coverage difference between downlink and uplink control may be greater than 20 decibels (dB) for frequency range 1 (FR 1) and greater than 10 dB for frequency range 2(FR 2 ). In such cases, a cell 205 identified based on the downlink metric may be unsuitable for uplink communications (e.g., based on the uplink performance being decreased compared to the downlink performance). Additionally, or alternatively, both reporting latency and power consumption at the UE 115-a may be increased to measure each cell 205 of the different cells 205 (e.g., with no assistance from the network).

The techniques, methods, and devices described herein may support cell selection in wireless communications systems. For example, the UE 115-a may identify and report one or more cells 205 for the mobility procedure according to uplink and downlink measurements. In some examples, the UE 115-a may identify a single cell 205 (e.g., a single target cell) that may be suitable for both uplink and downlink communications. In some other examples, the UE 115-a may identify and report multiple cells 205 (e.g., one or more target cells that may be separate for uplink and downlink).

In some implementations, the UE 115-a may receive control signaling 220 (e.g., via a downlink 210-a) that identifies (e.g., via a cell list) a set of cells 205 (e.g., candidate cells) associated with LTM (e.g., an LTM procedure for the UE 115-a) including the cell 205-b and the cell 205-c, among other examples. The control signaling 220 may further indicate one or more quality metrics (e.g., quality checks, quality thresholds, threshold conditions, or the like) associated with one or more communication links for the set of cells 205 (e.g., one or mor downlink quality metrics, or one or more uplink quality metrics, among other examples). The one or more communication links may include one or more downlinks 210, one or more uplinks 215, or both.

Additionally, or alternatively, the control signaling 220 may indicate one or more respective priority orders (e.g., measurement orders or ranking orders, among other examples) associated with the set of cells 205. For example, the control signaling 220 may indicate one or more downlink priority orders of the cells 205, one or more uplink priority orders of the cells 205, one or more combined (e.g., single) priority orders of the cells 205, or any combination thereof.

In some examples, the UE 115-a may receive one or more reference signals 225 from each cell of the set of cells. In some examples, the one or more reference signals 225 may be downlink reference signals (e.g., channel state information reference signals (CSI-RSs). For example, the UE 115-a may receive a reference signal 225-a (e.g., associated with the cell 205-b) via a downlink 210-b and a reference signal 225-b (e.g., associated with the cell 205-c) via a downlink 210-c. Additionally, or alternatively, the UE 115-a may receive one or more pathloss reference signals 230 (e.g., via the one or more downlinks 210). For example, the UE 115-a may receive a pathloss reference signal 230-a (e.g., associated with the cell 205-b) via a downlink 210-b and a pathloss reference signal 230-b (e.g., associated with the cell 205-c) via a downlink 210-c.

In some implementations, the UE 115-a may obtain measurements of one or more cells 205 the set of cells 205) via the one or more reference signals 225. Accordingly, the UE 115-a may obtain one or more downlink metrics (e.g., downlink RSRP) based on the measurements of the one or more reference signals 225, and the UE 115-a may derive (e.g., determine, calculate, or compute, among other examples) one or more uplink metrics (e.g., uplink RSRP) for each cell 205 of the set of cells 205 based on the downlink metrics. For example, the UE 115-a may determine the one or more uplink metrics based on the downlink metrics, one or more cell configuration parameters indicated by the control signaling 220, or both.

Additionally, or alternatively, the UE 115-a may derive the one or more uplink metrics based on the one or more pathloss reference signals 230. For example, the UE 115-a may determine (e.g., identify, detect, calculate, or the like) one or more downlink pathloss values based on receiving the one or more pathloss reference signals 230. Accordingly, the UE 115-a may determine the one or more uplink metrics based on the downlink pathloss values and the one or more cell configuration parameters indicated by the control signaling 220. For example, the UE 115-a may determine the uplink metrics based on a downlink pathloss value and an uplink transmission power value indicated by the control signaling 220.

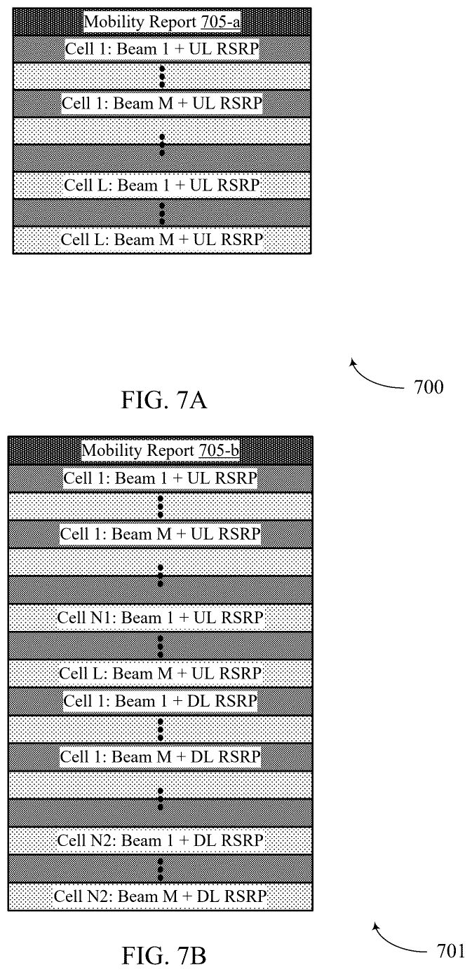

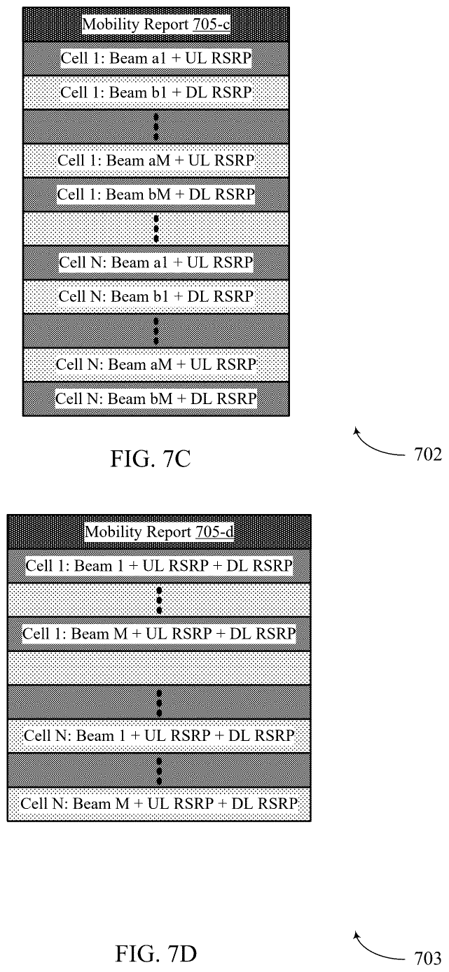

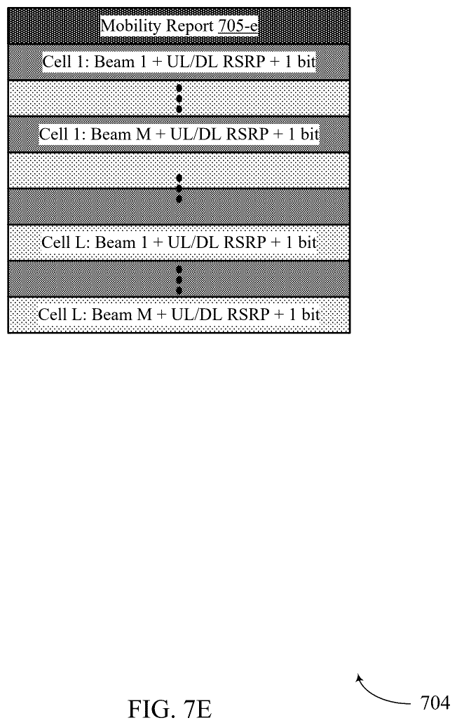

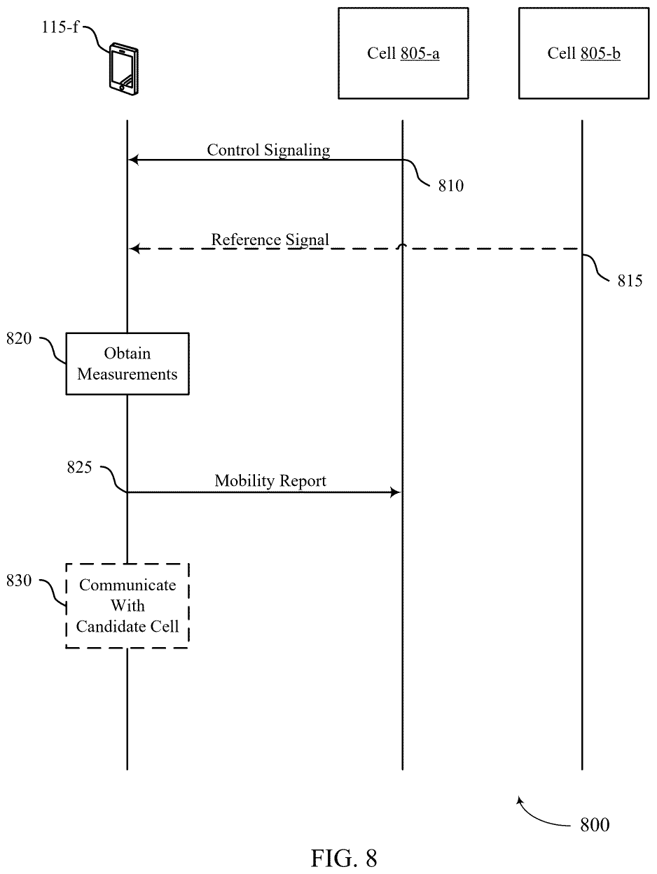

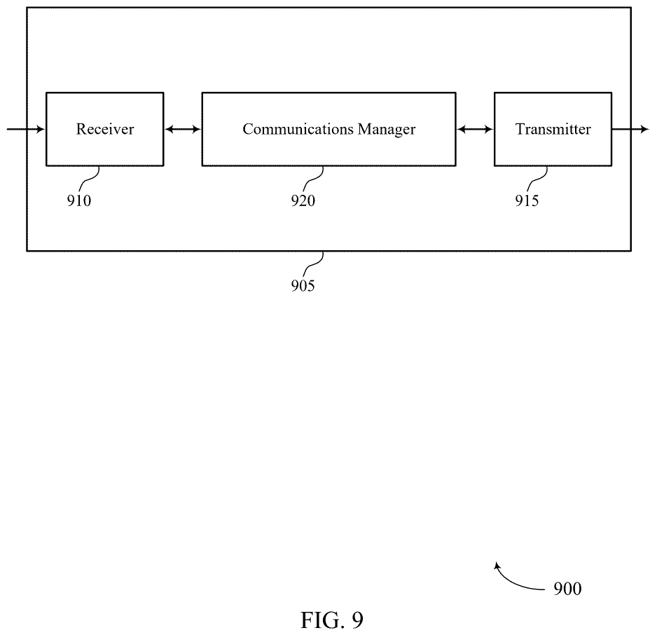

In some implementations, the UE 115-a may transmit (and the network entity 105 may obtain via an uplink 215-a) a mobility report 235 (e.g., an LTM report) including an indication of one or more metrics (e.g., downlink metrics, uplink metrics, composite metrics, or scaled metrics, among other examples) associated with at least a subset of cells 205 of the set of cells 205. The UE 115-a may transmit the mobility report 235 according to one or more report formats further described herein with reference to FIGS. 7A through 8C. The mobility report 235 may additionally include an indication of a quantity of beams associated with each cell 205 of the set of cells 205.

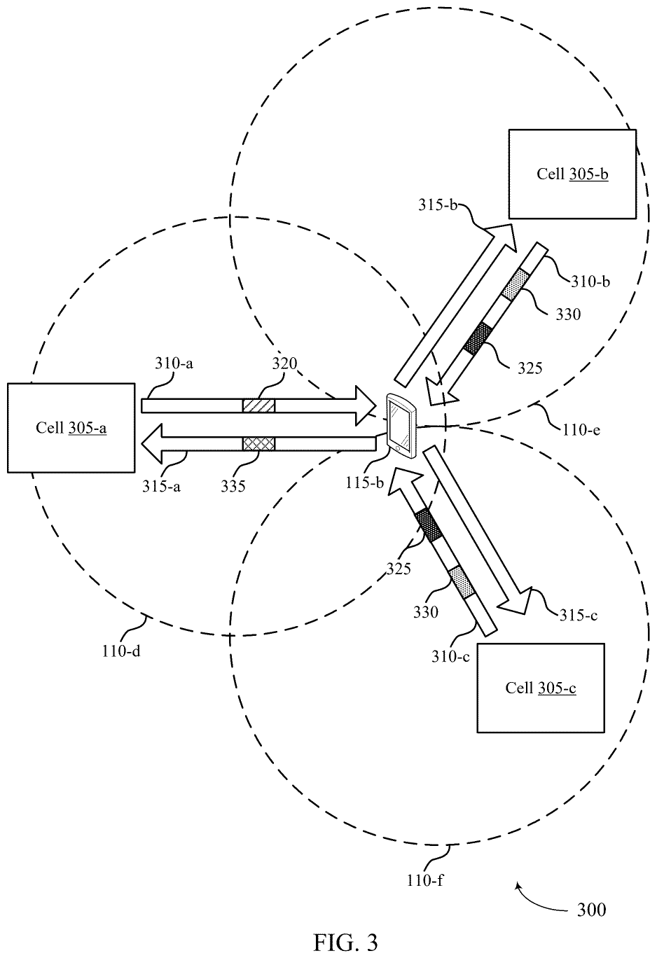

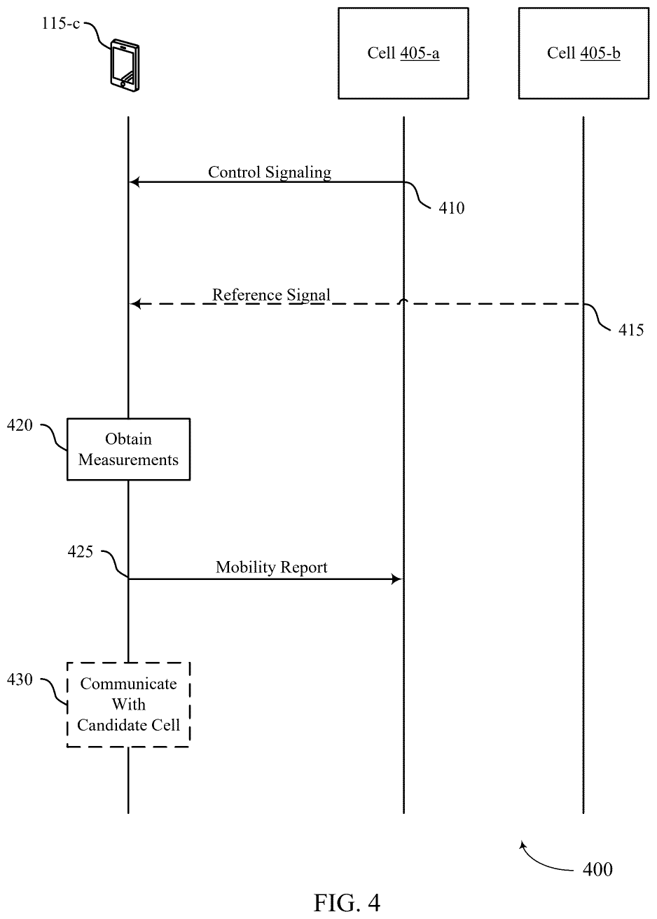

In some implementations, the UE 115-a may communicate with a single cell 205 based on transmitting the mobility report 235 (e.g., and on performing a mobility procedure). For example, measurements of the cell 205-b may be included within the mobility report, and may be suitable for downlink communications, uplink communications, or both (e.g., based on the determined downlink metrics, the determined uplink metrics, or both). Accordingly, the UE 115-a may perform uplink communications, downlink communications, or both with the cell 205-b. Techniques to measure, report, and select a single cell 205 for both uplink and downlink communications may be further described herein with reference to FIGS. 3 and 4.

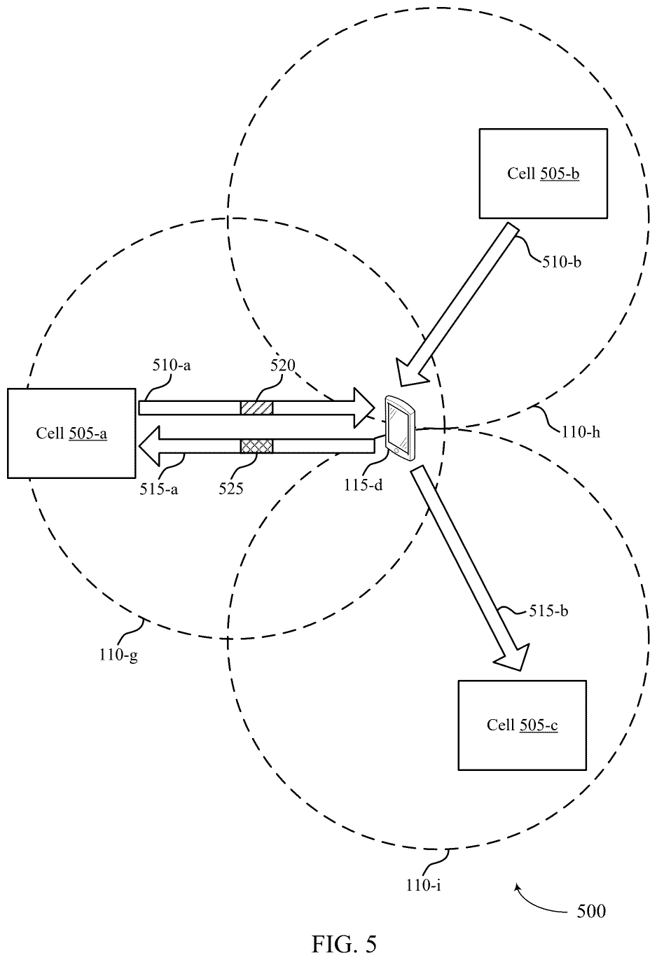

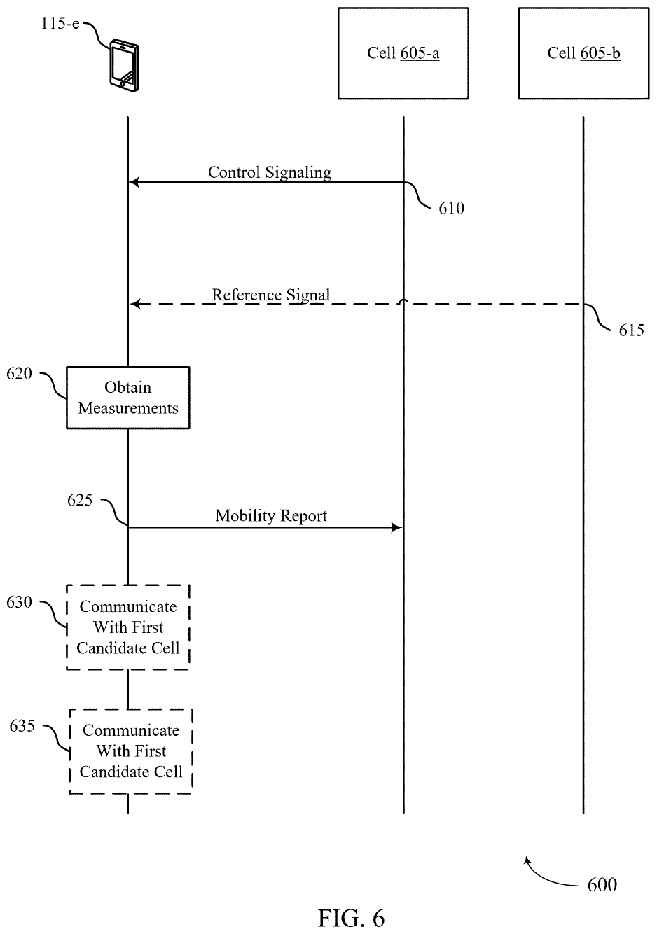

Additionally, or alternatively, the UE 115-a may communicate with multiple cells 205 (e.g., the cell 205-b for downlink communications, the cell 205-c for uplink communications, or the like) of the set of cells 205. For example, the UE 115-a may communicate with the cell 205-b via the downlink 210-b and communicate with the cell 205-c via the uplink 215-c. Alternatively, the UE 115-a may communicate with the cell 205-b via the uplink 215-b and communicate with the cell 205-c via the downlink 210-c. Techniques to measure, report, and select a first cell 205 for uplink communications and a second cell 205 for downlink communications may be further described herein with reference to FIGS. 5 and 6.

FIG. 3 shows an example of a wireless communications system 300 that supports cell selection in wireless communications systems in accordance with one or more aspects of the present disclosure. The wireless communications system 300 may implement, or be implemented by, aspects of the wireless communications system 100 and the wireless communications system 200, as described herein. For example, the wireless communications system 300 may include a UE 115-b, a cell 305-a, a cell 305-b, and a cell 305-c, which may be examples of corresponding entities as described herein.

The techniques described in the context of the wireless communications system 300 enables the UE 115-b to communicate with a single cell 305 for both uplink and downlink communications according to uplink measurements, downlink measurements, or both during a mobility procedure (e.g., handover procedure, LTM, L3 mobility).

For example, the UE 115-b may operate within the coverage area 110-d of the cell 305-a and communicate with the network via a downlink 310-a and an uplink 315-a of the cell 305-a. In some examples, the UE 115-b may move away from the coverage area 110-d of the cell 305-a and into the coverage areas 110-e and 110-f of the cells 305-b and 305-c, respectively, which may trigger a mobility procedure at the UE 115-b.

In such examples, as part of the mobility procedure, the UE 115-b may receive control signaling 320 (e.g., radio resource control (RRC) signaling, MAC signaling, downlink control information (DCI), among other examples) that provides a downlink measurement priority and a set of parameters to be used by the UE 115-b to identify an uplink measurement (e.g., uplink RSRP, uplink reference signal received quality (RSRQ), an uplink signal an interference to noise ratio (SINR), an uplink metric) per candidate cell 305 or per measured frequency. Accordingly, for each cell 305, the control signaling 320 may indicate a quality metric (e.g., a beam or cell quality threshold, a threshold RSRP, or threshold SINR) that each (or the average) of a threshold quantity of beams of a cell 305 should satisfy, where the threshold quantity of beams (e.g., X) may be indicated via the control signaling 320,

That is, the UE 115-b may receive control signaling 320 that indicates a set of cells 305, including the cell 305-b and the 305-b, that are candidates for selection during a mobility procedure. In such examples, the control signaling 320 may include a respective measurement priority for each cell 305 of the indicated set of cells 305 and may indicate a respective set of parameters for each cell 305 (or for each beam of a cell 305) of the set of cells 305 that may be used by the UE 115-b to obtain uplink measurements for each cell 305.

Further, the control signaling 320 may include an uplink quality metric (e.g., either per beam of a cell 305, per cell 305, or common for the set of cells 305) associated with the uplink measurements of the set of cells 305. The control signaling 320 may also include a threshold quantity of beams of cell 305 that should satisfy the uplink quality metric.

Accordingly, in response to receiving the control signaling 320 and as part of the mobility procedure, the UE 115-b may first measure the cells 305 of the set of cells 305 with the highest downlink priority. The UE 115-b may determine, for each cell 305 of the set of cells 305, a first quantity of cells, where each cell 305 of the quantity of cells 305 has a quantity of beams associated with an uplink measurement that satisfies the associated uplink quality metric, and where the quantity of beams of each cell 305 of the first quantity of cells 305 is greater than or equal to the threshold quantity of beams indicated via the control signaling 320. Accordingly, if the first quantity of cells 305 is less than a threshold quantity of cells 305 to be reported (indicated via the control signaling 320), the UE 115-b may continue to measure the cells 305 (e.g., frequencies) with lower priority and so on. If all cells 305 of the set of cells 305 have been measured, and the total quantity of cells 305 associated with uplink measurements that satisfy the uplink threshold is still less than the threshold quantity of cells to be reported, the UE 115-b may report the remaining cells 305 according to UE implementation.

In such examples, the downlink measurement priority for each cell 305 of the indicated set of cells 305 may be based on a downlink measurement (e.g., downlink RSRP, downlink RSRQ, downlink SINR, downlink metric) associated with each cell 305 and a downlink quality metric (e.g., threshold RSRP, threshold RSRQ, threshold SINR) indicated via the control signaling 320. For example, if a downlink RSRP of any cells 305 of the set of cells 305 is greater than the downlink RSRP threshold, the UE 115-b may select and report the cells 305 of the set of cells 305 with the higher measured RSRP and having higher priority, which may occur prior to checking the uplink quality metric for each cell 305. In such examples, the network entity 105 may generate the downlink RSRP threshold to improve a mean UE throughput on a selected target cell 305 across all locations associated with the UE 115-b and signaled by the network entity 105.

As described herein, the UE 115-b may measure a respective downlink measurement from each cell 305 using reference signals 325 (e.g., synchronization signal blocks (SSBs), CSI-RSs) or pathloss reference signals 330 associated with each cell 305 of the set of cells 305. In such examples, the UE 115-b may utilize the downlink measurements from each cell 305 in addition to a set of parameters configured for each cell 305 to obtain the uplink measurement for each cell 305.

For example, a network entity 105 may provide (e.g., indicate via control signaling 320, such as RRC signaling) one or more parameters per each cell 305 of the set of candidate cells 305 (e.g., per measured frequency, per TRP). A respective set of parameters may enable the UE 115 to estimate an uplink measurement (e.g., via one or more uplink metrics) for the corresponding cell 305. For example, the set of parameters for the cell 305-b may include a first bandwidth, a first offset in transmission power, a first pathloss metric, a first load indicator (e.g., traffic load), a first percentage of utilization (e.g., a percentage of utilized resources), a first quantity of active connections (e.g., uplink connections, downlink connections, or both), among other examples.

As such, using the respective set of parameters for each cell 305 of the set of cells 305, the UE 115-b may determine an uplink measurement for each cell 305 of the set of cells 305. In such examples, the uplink measurement may include an uplink RSRP. In some examples, the UE 115-b may determine the uplink RSRP based on one or more downlink reference signals 325 (e.g., corresponding to an uplink reference signal), where the UE 115-b may derive the uplink RSRP based on the downlink reference signal 325. For example, the downlink reference signal may be quasi co-located (QCL) with an uplink reference signal (e.g., QCL with the uplink reference signal based on corresponding to a same transmission configuration indication (TCI) state as the uplink reference signal).

Accordingly, the UE 115-b may first receive the downlink reference signal 325 and measure the downlink RSRP of the downlink reference signal 325. The UE 115-b may further determine the uplink RSRP based on a difference between a configured uplink transmission power (e.g., indicated to the UE 115-b via the control signaling 320), the downlink RSRP, and a downlink RSRP offset value (e.g., uplink RSRP=uplink Tx power-downlink RSRP+offset). In some examples, the network entity 105 may configure the offset value to compensate for a difference between a downlink transmission power and an uplink transmission power (e.g., the downlink transmission power).

Additionally, or alternatively, the UE 115-b may determine the uplink RSRP value based on a pathloss reference signal 330 that corresponds to an uplink reference signal of the UE 115-b (e.g., the downlink reference signal may be the path loss reference signal for the uplink reference signal). Accordingly, the UE 115-b may first identify the downlink pathloss of the channel between the UE 115-b and the cell 305 via the pathloss reference signal 330. The UE 115-b may derive the uplink RSRP value based on the downlink pathloss. For example, the UE 115-b may derive the uplink RSRP according to a difference between a configured uplink transmission power (e.g., indicated via the control signaling 320) and the pathloss value (e.g., uplink RSRP=UL Tx power−PathLoss).

In such examples, the UE 115-b may determine an uplink RSRP for multiple beams of each cell 305 of the set of cells 305. For example, if the cell 305-b is associated with five beams, the UE 115-b may receive one or more reference signals 325 or pathloss reference signals 330 from the five beams and determine a respective uplink RSRP for each of the five beams of the cell 305-b.

As an illustrative example, the UE 115-b may receive, via the control signaling 320, an indication of a set of cells 305, a respective downlink measurement priority of each cell of the set of cells 305, an uplink quality metric for each cell 305 of the set of cells 305, a downlink quality metric for each cell 305 of the set of cells 305, an indication that at least 3 beams of each cell 305 are to satisfy the associated uplink quality metric in order to be reported, an indication that the UE 115-b is to report at least 3 cells 305 of the set of cell 305 via the mobility report, a set of parameters for each cell 305 of the set of cells 305, or any combination thereof.

Accordingly, in response to receiving the control signaling 320 and for the cell 305-b (e.g., a first cell) of the set of cells 305 having the highest priority, the UE 115-b may obtain a respective downlink measurement for each beam associated with the cell 305-b using the reference signals 325 or the pathloss reference signals 330. Based on obtaining the respective downlink measurements, the UE 115-b may compare the respective downlink measurements to the corresponding downlink quality metric. If the respective downlink measurements satisfy the corresponding downlink quality metric, the UE 115-b may derive a respective uplink measurement for each beam of the cell 305-b using the corresponding downlink measurement and the set of parameters associated with the cell 305-b, as described herein.

Based on obtaining the respective uplink measurements, the UE 115-b may compare the respective uplink measurements to the corresponding uplink quality metric. If at least 3 of the respective uplink measurements satisfy the corresponding uplink quality metric, meaning that at least 3 uplink beams of the cell 305-b satisfy the uplink quality metric, the UE 115-b may select the cell 305-b to be reported via the mobility report 335, which may be formatted according to the report formats as described herein with reference to FIGS. 7A through 7E. The UE 115-b may proceed to perform similar operations for the next highest priority cell 305, such as the cell 305-c, until the UE 115-b has identified at least 3 cells 305 of the set of cells 305 to be reported via the mobility report 335. In this way, the UE 115-b may select and report cells 305 according to both uplink and downlink measurements, thereby enabling the UE 115-b to connect to a cell 305 sufficient for both uplink and downlink communications.

In some other examples, the UE 115-b may receive control signaling 320 that provides an uplink measurement priority and a downlink quality metric (e.g., downlink RSRP threshold, downlink SINR threshold, downlink RSRQ threshold, downlink quality threshold) per candidate cell 305 or per measured frequency. That is, for each cell 305, the control signaling 320 may indicate a downlink quality that each (or the average) of a threshold quantity of beams of a cell 305 should satisfy, where the threshold quantity of beams (e.g., X) may be indicated via the control signaling 320,

For example, the UE 115-b may receive control signaling 320 that indicates a set of cells 305, including the cell 305-b and the 305-b, that are candidates for selection during a mobility procedure. In such examples, the control signaling 320 may include a respective uplink measurement priority for each cell 305 of the indicated set of cells 305 and may indicate a downlink quality metric (e.g., either per beam of a cell 305, per cell 305, or common for the set of cells 305) associated with the downlink measurements of the set of cells 305. The control signaling 320 may also include a threshold quantity of beams of cell 305 that should satisfy the downlink quality metric.

Accordingly, in response to receiving the control signaling 320 and as part of the mobility procedure, the UE 115-b may first measure the cells 305 of the set of cells 305 with the highest uplink priority. The UE 115-b may determine, for each cell 305 of the set of cells 305, a first quantity of cells, where each cell 305 of the quantity of cells 305 has a quantity of beams associated with a downlink measurement that satisfies the associated downlink quality metric, and where the quantity of beams of each cell 305 of the first quantity of cells 305 is greater than or equal to the threshold quantity of beams indicated via the control signaling 320.

Accordingly, if the first quantity of cells 305 is less than a threshold quantity of cells 305 to be reported (indicated via the control signaling 320), the UE 115-b may continue to measure the cells 305 (e.g., frequencies) with lower priority and so on. If all cells 305 of the set of cells 305 have been measured, and the total quantity of cells 305 associated with downlink measurements that satisfy the downlink threshold is still less than the threshold quantity of cells to be reported, the UE 115-b may report the remaining cells 305 according to UE implementation.

As an illustrative example, the UE 115-b may receive, via the control signaling 320, an indication of a set of cells 305, a respective uplink measurement priority of each cell of the set of cells 305, an uplink quality metric for each cell 305 of the set of cells 305, a downlink quality metric for each cell 305 of the set of cells 305, an indication that at least 3 beams of each cell 305 are to satisfy the associated downlink quality metric in order to be reported, an indication that the UE 115-b is to report at least 3 cells 305 of the set of cell 305 via the mobility report, a set of parameters for each cell 305 of the set of cells 305, or any combination thereof.

Accordingly, in response to receiving the control signaling 320 and for the cell 305-b (e.g., a first cell) of the set of cells 305 having the highest uplink priority, the UE 115-b may obtain a respective downlink measurement for each beam associated with the cell 305-b using the reference signals 325 or the pathloss reference signals 330. Based on obtaining the respective downlink measurements, the UE 115-b may compare the respective downlink measurements to the corresponding downlink quality metric. If the respective downlink measurements of at least 3 beams of the cell 305 satisfy the corresponding downlink quality metric, meaning that at least 3 downlink beams of the cell 305-b satisfy the downlink quality metric, the UE 115-b may derive a respective uplink measurement for each beam of the cell 305-b using the corresponding downlink measurement and the set of parameters associated with the cell 305-b, as described herein.

Based on obtaining the respective uplink measurements, the UE 115-b may compare the respective uplink measurements to the corresponding uplink quality metric. If the respective uplink measurements satisfy the corresponding uplink quality metric, the UE 115-b may select the cell 305-b to be reported via the mobility report 335, which may be formatted according to the report formats as described herein with reference to FIGS. 7A through 7E. The UE 115-b may proceed to perform similar operations for the next highest priority cell 305, such as the cell 305-c, until the UE 115-b has identified at least 3 cells 305 of the set of cells 305 to be reported via the mobility report 335. In this way, the UE 115-b may select and report cells 305 according to both uplink and downlink measurements, thereby enabling the UE 115-b to connect to a cell 305 sufficient for both uplink and downlink communications.

In some other examples, the UE 115-b may implicitly determine the frequency, RAT, and cell measurement priority based on the ID of the corresponding RRC message, the order index of the corresponding RRC message in the associated list (one for downlink and one for uplink), or both. That is, instead of explicitly providing the uplink or downlink priorities of the set of cells 305, the UE 115-b may determine the priority of the set of cells 305 according to the respective IDs associated with each cell 305 of the set of cells 305 (e.g., a measurement object ID, measurement ID associated with the cell 305, or the physical cell ID of the cells 305) or according to an index associated with each cell 305 of the set of cells 305 (e.g., an index of each cell in the CellsToAddModList of the MeasObjectNR information element). In some examples, the control signaling 320 may include a flag that indicates for the UE 115-b to determine the priorities of the set of cells 305 implicitly (e.g., according to the IDs).

As an illustrative example, in the case of L3 measurement-based mobility, the control signaling 320 (e.g., RRC message) may include measurement object information elements, report configuration information elements, and individual cell information elements. Accordingly, the UE 115-b may determine the measurement priority of the frequency, RAT, and cells 305 by the associated measurement ID or measurement object ID. In such examples, a smaller ID value may imply higher priority. Similarly, a smaller order index in the measurement ID list or measurement object ID list may imply higher priority. Among cells 305 associated with the same measurement ID or measurement object ID, the UE 115-b may determine the measurement priority of each cell 305 according to the order index in the cell list (e.g., CellsToAddModList) of the control signaling 320 (e.g., smaller order index implies higher priority).

As another illustrative example, in the case of L1 measurement-based mobility, the UE 115-b may determine the priorities of the cells 305 of the set of cells 305 according to the candidate cell ID or the candidate configuration ID. For example, the control signaling 320 (in L1 measurement-based mobility) may include an LTM CSI resource configuration information element included within an LTM CSI report configuration information element, where the LTM CSI resource configuration information element indicates the candidate cell list (e.g., ltm-CandidateIdList). In such examples, the candidate cell list may include multiple candidate cell IDs (e.g., LTM-Candidate ID).

Accordingly, the UE 115-b may determine the measurement priority for each cell 305 of the set of cells 305 (and associated frequency and RAT) according to the corresponding candidate cell ID or candidate configuration ID within the LTM candidate cell list. In such examples, a smaller ID value may imply higher priority. In some other examples, the UE 115-b may determine the measurement priority for each cell 305 of the set of cells 305 according to the order index in the candidate cell list (e.g., ltm-CandidateIDList), where a smaller order index may imply higher priority.

In some examples, for the UE 115-b to prioritize and select for reporting the cells 305 from the set of cell 305 based on the uplink measurement during the mobility procedure, the UE 115-b may receive, via the control signaling 320, one or more combining rules, one or more coefficients, or both for the UE 115-b to use in evaluating a single composite metric. As described herein, the UE 115-b may obtain the composite metric as a combination of an uplink measurement (e.g., uplink RSRP) and a downlink measurement (e.g., downlink RSRP) for a cell 305 (or a beam of a cell 305).

As an illustrative example, the UE 115-b may obtain an uplink measurement of a first beam of the cell 305-b to be X and obtain a downlink measurement of the first beam of the cell 305-b to be Y. Accordingly, if the coefficient indicated via the control signaling 320 is 0.5 and the combining rule is addition, the UE 115-b may obtain the composite metric for the first beam of the cell 305-b to be equal to 0.5X +0.5Y.

The UE 115-b may utilize the composite metrics to rank the beams of a cell 305 and the cells 305 of the set of cells 305. As one example, a higher value for the composite metric may indicate a higher priority. As such, in the case of network-initiated cell mobility (e.g., cell switch), the UE 115-b may prioritize the reported cells 305 according to ranking of the composite metrics of each cell 305 of the set of cells 305. Similarly, in the case of UE-initiated cell mobility (e.g., cell switch), the UE 115-b may select a target cell 305 according to the ranking of the composite metrics of each cell 305 of the set of cells 305.

In some examples, in addition to the composite metric and combining rules, the UE 115-b may receive, via the control signaling 320, scaling factors, offsets, or both for uplink measurements, downlink measurements, the composite metric, or any combination thereof per cell 305 or per measured frequency. That is, the UE 115-b may receive, for the cell 305-b, a first scaling factor (first offset) for uplink measurements, a second scaling factor (second offset) for downlink measurements, and/or a third scaling factor (third offset) for a composite metric.

In such examples, the same scaling factor or offset may be indicated per cell 305 or per cells 305 within an associated frequency. In this way, the downlink measurements (e.g., RSRP, SINR, RSRQ) may be multiplied with the downlink scaling factor (between 0 and 1) or added with a downlink offset, with the value specified as a function of the parameters of cell 305. Similarly, the uplink measurements (e.g., RSRP, RSRQ, SINR) may be multiple with an uplink scaling factor or added with an uplink offset, as a function of the cell parameters. Accordingly, a higher value for larger cell 305 (e.g., larger bandwidth part) may be obtained, while a lower value for a higher load may be obtained. Further, the UE 115-b may apply a composite scaling factor, or a composite offset, to the composite metric for a cell 305, as a function of the cell parameters.

In this way, the UE 115-b may report a threshold quantity of cells 305 (or beams of the cells) in the mobility report 335 by ranking the cells 305 (or beams) according to the scaled or offset measurements.

As an illustrative example, the UE 115-b may receive, via the control signaling 320, a set of cells 305 for the mobility procedure, where each cell 305 may be associated with a respective downlink scaling factor (or offset) and a respective uplink scaling factor (or offset). The UE 115-b may obtain, per cell 305 or per beam per cell 305, a respective uplink measurement and a respective downlink measurement. As such, the UE 115-b may apply the respective uplink scaling factor (or offset) to the respective uplink measurement for the cell 305-b to obtain a first adjusted metric for the cell 305-b. Similarly, the UE 115-b may apply the respective downlink scaling factor to the respective downlink measurement of the cell 305-b to obtain a second adjusted metric for the cell 305-b. The UE 115-b may obtain the first and second adjusted metrics for each cell 305 within the set of cells 305 and proceed to rank the cells 305 according to the values of the first and second adjusted metrics. The UE 115-b may report a subset of the set of cells 305 via the mobility report 335, where first and second adjusted metrics of each of the subset of cells 305 satisfied a threshold (e.g., were the top beams/cells).

In some examples, in addition to ranking (e.g., prioritizing) the cells 305 according to the scaled or offset measurements (e.g., scaled or offset uplink measurements, scaled or offset downlink measurements, scaled or offset composite metrics), the UE 115-b may also prioritize cells 305 of the set of cells 305 or the beams of a cell 305 according to an adjusted downlink threshold and an adjusted uplink threshold. As described herein the adjusted metric is obtained by applying the scaling factor or offset on the associated measurement or composite metric.

As an illustrative example, the UE 115-b may obtain a downlink adjusted metric for the cell 305-b and an uplink adjusted metric for the cell 305-b. Accordingly, the UE 115-b may determine to report the cell 305-b via the mobility report 335 in the case that the downlink adjusted metric satisfies (e.g., is greater than) the adjusted downlink threshold and the uplink adjusted metric satisfies (e.g., is greater than) the adjusted uplink threshold (e.g., downlink adjusted metric >downlink configured threshold AND uplink adjusted metric>uplink configured threshold).

In some examples, the UE 115-b may apply a tie-breaking rule in case two beams of a cell 305 or two cells 305 satisfy both the uplink and downlink adjusted thresholds. For example, the UE 115-b may select the beam of the two beams of the cell 305 or the cell 305 of the two cells 305 that has a minimum or maximum weighted sum value for the adjusted downlink metric and the adjusted uplink metric. In some other examples, the UE 115-b may select the cell 305 or the beam of a cell 305 that has the highest adjusted composite metric.

In this way, by reporting cells 305 that are sufficient for both uplink and downlink communications, the UE 115-b or the network entity 105 may select a single cell 305 for both uplink and downlink communications according to the mobility report 335. As an illustrative example, the UE 115-b (or the network entity 105) may select the cell 305-b as the target cell 305, such that the UE 115-b communicates via the downlink 310-b and the uplink 315-b with the cell 305-b. Alternatively, the UE 115-b (or the network entity 105) may select the cell 305-c as the target cell 305, such that the UE 115-b communicates via the downlink 310-c and the uplink 315-c with the cell 305-c.

FIG. 4 shows an example of a process flow 400 that supports cell selection in wireless communications systems in accordance with one or more aspects of the present disclosure. The process flow 400 may implement, or be implemented by, aspects of the wireless communications system 100, the wireless communications system 200, and the wireless communications system 300 as described herein. For example, the process flow 400 may include a UE 115-c and cells 405-a and 405-b, which may be examples of corresponding entities as described herein. The techniques described in the context of the process flow 400 enable the UE 115-c to measure, report, and/or select a single cell 405 for both uplink and downlink communications according to uplink measurements, downlink measurements, or both.

At 410, the UE 115-c may receive control signaling (e.g., control signaling 320), where the control signaling may identify a set of cells 405 (e.g., two or more candidate cells, including the cell 405-b) associated with a mobility procedure at the UE 115-c. For example, the UE 115-c may be connected to a cell 405-a and receive control signaling from the cell 405-a as part of a handover procedure from the cell 405-a.

In some examples, the control signaling may indicate a quality metric (e.g., a quality threshold) associated with uplink communications (e.g., first communication link) and indicate a respective priority for measuring downlink communications (e.g., a second communication link). In some other examples, the control signaling may indicate a quality metric associated with downlink communications and indicate a respective priority for measuring the uplink communications.

In some examples, the UE 115-c may receive a first quality metric associated with uplink communications and a second quality metric associated with downlink communications, such that the UE 115-c may select cells 405 using the first and second quality metrics.

In addition to the quality metrics and priorities, the UE 115-c may receive, via the control signaling, a rule for combining downlink and uplink measurements, a scaling factor associated with uplink measurements, a scaling factor associated with downlink measurements, a threshold quantity of cells 405 to be reported, or a combination thereof, as described herein with reference to FIG. 3.

At 415, the UE 115-c may receive one or more reference signals from each of the set of cells 405. For example, the UE 115-c may receive a respective reference signal from one or more beams of the cell 405-b. In some examples, the reference signals may be CSI-RSs, pathloss reference signals, or both. At 420, the UE 115-c may obtain uplink measurements and downlink measurements of one or more cells 405 of the set of cells 405 using the reference signals received at 415 according to the techniques described herein with reference to FIG. 3.

At 425, the UE 115-c may transmit a mobility report, where the mobility report may indicate a subset of cells 405 of the set of cells 405. The UE 115-c may select the subset of cells 405 according to the uplink measurements, the uplink quality metric, the downlink measurements, the downlink quality metric, or any combination thereof according to the techniques described herein with reference to FIG. 3. In such examples, the quantity of cells 405 of the subset of cells 405 may be at least greater than or equal to the threshold quantity of cells indicated via the control signaling. The mobility report may be an example of one of the formats described herein with reference to FIGS. 7A through 8C.

At 430, the UE 115-c may communicate a first cell 405 of the subset of cells 405 reported in the mobility report for both uplink and downlink communications. That is, the UE 115-c (or the network entity 105) may select the first cell 405 from the subset of cells 405, such that the UE 115-c may communicate with the first cell 405 for both uplink and downlink communications. As an illustrative example, the cell 405-b may be selected as the handover target cell, such that the UE 115-c may perform the handover procedure to the cell 405-b.

FIG. 5 shows an example of a wireless communications system 500 that supports cell 505 selection in wireless communications systems in accordance with one or more aspects of the present disclosure. Aspects of the wireless communications system 500 may implement, or be implemented by, aspects of the wireless communications system 100, the wireless communications system 200, the wireless communications system 300, and the process flow 400 as described herein with reference to FIGS. 1 through 4. For example, the wireless communications system 500 may include a UE 115-d, a cell 505-a, a cell 505-b, and a cell 505-c, which may be examples of corresponding entities, as described herein.

The techniques described in the context of the wireless communications system 500 may enable the UE 115-d (or a network entity 105) to select a cell 505-c (e.g., a first cell 505) for uplink communications and select a cell 505-b (e.g. a second cell 505) for downlink communications.

In some cases, selecting a target cell 505 (e.g., a target beam, a target TRP) having a relatively high downlink throughput (e.g., a suitable downlink throughput of a set of available cells 505) may not guarantee a correspondingly high uplink throughput (e.g., suitable uplink throughput of a set of available cells 505). That is, as described herein, selecting a single cell 505 for both uplink and downlink communications according to a downlink throughput of the single cell 505 may lead to selection of a cell 505 not suitable for uplink communications. Thus, it may be beneficial for the UE 115-d to connect to report separate downlink and uplink preferred target cells 505 205 in a mobility report 525.

For example, an uplink transmission power may be different across different cells 505, different beams, different TRPs, or the like. In some cases, a maximum permissible exposure (MPE) factor may be applied to a target cell 505 selected for downlink (e.g., MPE issue in suitable downlink cell 505), while an MPE factor may be absent from a different cell 505 that provides relatively high uplink performance (e.g., no MPE issue in a different cell 505 that is suitable for uplink). Additionally, or alternatively, an uplink transmission power for the target cell 505 selected for downlink may be lower than a downlink transmission power due to power sharing with other FRs or RATs for the selected cell 505 (e.g., LTE/4G connection and 5G FR1 is overlapping with the suitable downlink cell 505).

However, if another cell 505 that is well-separated (e.g., separated in distance, or isolated, among other examples) from an overlapping band is present (e.g., a well-separated cell 505 supported by a dedicated power amplifier and not sharing uplink transmission power), the well-separated cell 505 may be suitable for uplink (e.g., while being unsuited for downlink communications). Additionally, or alternatively, one or more cells 505 of the set of cells 505 may provide uplink communications (e.g., be uplink only TRPs, or uplink-only cells 505, be cells 505 that are unsuitable for downlink communications).

In some other cases (e.g., regarding L3 mobility), a cell 505 load, available resources (e.g., time domain or frequency domain resources), transmission or reception capabilities, or available hardware, among other examples, may be different for downlink communications and uplink communications in a given cell 505. In TDD, a slot or symbol pattern, a quantity of uplink or downlink layers, respective downlink or uplink bandwidth, or the like, may lead to asymmetric uplink and downlink performance after a cell 505 handover procedure (e.g., cell 505 switch). In FDD, a cell 505 bandwidth for downlink and uplink, or time resources, frequency resources, or spatial resources for uplink could be different from time resources, frequency resources, or spatial resources for downlink. Additionally, or alternatively, a target cell 505 may have a higher downlink load (e.g., downlink traffic load) than an uplink load, and the uplink load, the downlink load, or both may vary dynamically (e.g., vary with time), which may lead to relatively poor quality of service (QoS) after a cell 505 handover procedure. In such cases, additional signaling may be included (e.g., between the network and a UE 115-d) for the UE 115-d to estimate downlink and uplink throughput individually, which may increase signaling overhead.

In some cases, regarding LTM procedures (e.g., regarding L1 or L2 mobility), a cell 505 configuration may include information corresponding to available uplink and downlink bandwidth, or a quantity of MIMO layers, among other examples, for a UE 115-d (e.g., such as the UE 115-d) to estimate an uplink throughput and a downlink throughput separately. However, the UE 115-d may be unable to report a preference (e.g., operating heuristic) to switch to separate cells 505 or TRPs (e.g., one for downlink and one for uplink). For example, an uplink SINR and uplink load (e.g., a measurement for uplink SINR or uplink loading) may vary compared to an LTM cell 505 configuration (e.g., unlike downlink SINR or RSRP measurements). Additionally, or alternatively, an uplink throughput may vary in accordance with an uplink resource (e.g., uplink bandwidth), an uplink load, an uplink transmission power, or the like, and uplink throughput prediction (e.g., based on a serving cell 505 configuration and without assistance or an indicated priority list from a network) may be ineffective (e.g., compared to downlink throughput prediction). Accordingly, a UE 115-d may store an indication of (e.g., memorize) one or more link curves for uplink throughput estimation according to an uplink RSRP measurement, which may increase overhead and memory consumption.

A quantity of candidate list configurations may be a fixed quantity. In such cases, the UE 115-d may process and store (e.g., process and memorize) the serving cell 505 configuration info. In some cases, the UE 115-d may measure and report target cells 505 based on UE 115-d decision (e.g., UE 115-d-side decision, or UE 115-d implementation). For example, a first quantity of cells 505 (e.g., eight cells 505) in a candidate list may be reported with full information (e.g., each reporting parameter for the first quantity of cells 505 may be reported), and a second quantity (e.g., N) cells 505 may be reported with measurement reference signals and PCIDs (e.g., with an associated separate uplink and downlink priority). In such cases, the UE 115-d may report additional parameters associated with the second quantity of cells 505 after performing a cell 505 switch

Additionally, or alternatively, simplified parameters for estimating cell 505 quality or prioritizing cells 505 for downlink and prioritizing cells 505 for uplink may enable a UE 115-d to utilize a relatively reduced amount of processing (e.g., compared to non-simplified configurations to parse the configuration (e.g., for a large quantity cells 505), which may enable the UE 115-d to evaluate more cells 505 for handover (e.g., across FRs and across RATs). For example, a serving cell 505 configuration may include a subset of the set of cells 505 (e.g., a set of cells 505 most likely to provide relatively high uplink performance, relatively high downlink performance, or both). Accordingly, a remainder of cells 505 of the subset of cells 505 may be indicated via simplified parameters for the remainder (e.g., for low-memory UEs).

In some cases, as a UE 115-d implementation, the UE 115-d may prioritize reporting cells 505 based on stored (e.g., memorized) cell 505 information. For example, the UE 115-d may prioritize cells 505 with relatively greater bandwidth, a relatively greater quantity MIMO layers, one or more load parameters, a throughput metric, or a latency metric, among other examples, as indicated in the serving cell 505 configuration of cells 505. However, prioritizing cells 505 based on stored cell 505 information may consume UE 115-d memory (e.g., if the cell 505 parameters vary across cells 505). Additionally, or alternatively, a quantity of cells 505 included within a cell 505 configuration may be based on a network capability, the stored cell 505 parameters may be inaccurate if they vary across time (e.g., a cell 505 load may vary across time), a cell 505 load parameter may be unavailable, a higher load may occur (e.g., frequently occur) based on throughput-demanding applications, or the stored cell 505 info may be unavailable (e.g., at a different location), among other examples.

In accordance with the techniques described herein, the UE 115-d may connect with the cell 505-c for uplink communications and the cell 505-b for downlink communications according to a mobility procedure that is based on both uplink and downlink measurements. By doing so, the UE 115-d may obtain an uplink 515-b having an uplink metric (e.g., RSRP, RSRQ, SINR, throughput) that satisfies an uplink quality metric and have obtain a downlink 510-b having a downlink metric (e.g., RSRP, RSRQ, SINR, throughput) that satisfies a downlink quality metric.

For example, the UE 115-d may be connected to the cell 505-a and move out of the coverage area 110-g of the cell 505-a and into the coverage areas 110-h and 110-i of the cells 505-b and 505-c, respectively. Accordingly, as part of a mobility procedure (e.g., handover procedure, LTM), the UE 115-d may receive control signaling 520 indicating a configuration for separate uplink and downlink prioritized cell reports.

In some examples, as part of the mobility procedure (e.g., LTM or L3 triggered mobility), the UE 115-d may receive control signaling 520 from a network entity 105 operating the cell 505-a via the downlink 510-a, where the control signaling 520 provides a downlink measurement priority and an uplink measurement priority per cell 505, per measured frequency, or per TRP. For example, the control signaling 520 may indicate a first set of cells 505 (e.g., uplink candidate cells) associated with uplink communications and a second set of cells 505 (e.g., downlink candidate cells) associated with downlink communications. In such examples, the control signaling 520 may also include a respective measurement priority for each cell 505 of the first set of cells 505 and include a respective measurement priority for each cell 505 of the second set of cells 505. The first set of cells 505 and the second set of cells 505 may be the same cells 505 (e.g., indicated as a single list or two lists) or be different cells 505. Further, the UE 115-d may receive, via the control signaling, a threshold quantity of cells to be reported via the mobility report 525.

Accordingly, within each uplink priority (e.g., for the first set of cells 505), the control signaling 520 may indicate an uplink quality metric (e.g., cell or beam quality threshold), such as a threshold uplink RSRP or SINR that each (or average) of a threshold quantity of beams (e.g., top X beams) of an uplink cell 505 should satisfy, where the threshold quantity of beams may be indicated via the control signaling 520. That is, the control signaling 520 may indicate one or more uplink quality metrics for the first set of cells 505, such that, for the UE 115-d to report a cell 505 for the mobility procedure, the measured uplink metrics (e.g., RSRP or SINR) of a threshold quantity of beams (e.g., top X beams) of the reported cell 505 are to satisfy an associated uplink quality metric.

Likewise, within each downlink priority (e.g., for the second set of candidate cells), the control signaling 520 may indicate a downlink quality metric, such as a threshold RSRP or SINR that each (or average) of a threshold quantity of beams of a downlink cell 505 should satisfy, where the threshold quantity of beams (e.g., Y beams) may be indicated via the control signaling 520. That is, the control signaling 520 may indicate one or more downlink quality metrics for the second set of cells 505, such that, for the UE 115-d to select a cell 505 for the mobility procedure from the second set of cells, the measured downlink metrics (e.g., RSRP or SINR) of a threshold quantity of beams (e.g., top Y beams) of the selected cell 505 are to satisfy the associated downlink quality metric.

In response to receiving the control signaling 520, the UE 115-d may measure the cells 505 (or frequency) with the highest priority, for example, a first measurement based on downlink priority and a first measurement based on uplink priority. Accordingly, if total quantity of cells 505 with a quality metric (e.g., cell or beam RSRP or SINR) above the indicated thresholds is less than the threshold quantity of cells to be reported (as indicated via the control signaling 520, the UE 115-d may continue to measure cells 505 (or frequency) with a lower priority and so on, within the respective priority lists. Further, if all cells 505 have been measured, but the total quantity of cells with a quality metric above the indicated thresholds (e.g., RSRP or SINR) for the corresponding priority is less than the threshold quantity of cells to be reported, the UE 115-d may select the remaining cells 505 to be reported according to UE implementation.

As an illustrative example, the threshold quantity of beams may be three and the threshold quantity cells to be reported for the uplink communications may also be three. Accordingly, the UE 115-d may obtain a respective uplink measurement (e.g., first measurement) for beams of the cell 505-c having the highest priority of the first set of cells 505 (according to the techniques described herein with reference to FIG. 3). If the respective uplink measurements for at least three beams of cell 505-c are greater than or equal to the associated uplink quality metric, the UE 115-d may determine to report the cell 505-c via the mobility report 525. The UE 115-d may then obtain the respective uplink measurement for beams of a second cell 505 having the second highest priority of the first set of cells 505. As such, if the respective uplink measurement for at least three beams of the second cell 505 is greater than or equal to the associated uplink quality metric, the UE 115-d may determine to report the second cell 505. The UE 115-d may continue to perform such operations for the next highest priority cell 505 of the first set of cells 505 until the UE 115-d has identified three cells 505 to be reported.

The UE 115-d may perform similar operations for downlink communications of the second set of cells 505 (e.g., measure the beams of the cell 505-b, determine whether a threshold quantity of beams of the cell 505-b satisfy the associated downlink quality metric, and repeat the process for the next highest priority cell 505). In response, the UE 115-d may report the identified cells via the mobility report 525.

In some other examples, the UE 115-d may implicitly determine the frequency, RAT, and cell measurement priority for downlink communications and the frequency, RAT, and cell measurement priority for uplink communications based on the ID of the corresponding RRC message, the order index of the corresponding RRC message in the associated list (one for downlink and one for uplink), or both.

That is, instead of explicitly providing the priorities of the first set of cells 505, the UE 115-d may determine the priority of the first set of cells 505 according to the respective IDs associated with each cell 505 of the first set of cells 505 (e.g., a measurement object ID, measurement ID associated with the cell 505, or the physical cell ID of the cells 505) or according to an index associated with each cell 505 of the first set of cells 505 (e.g., an index of each cell in the CellsToAddModList of the MeasObjectNR information element).

Similarly, instead of explicitly providing the priorities of the second set of cells 505, the UE 115-d may determine the priority of the second set of cells 505 according to the respective IDs associated with each cell 505 of the second set of cells 505 (e.g., a measurement object ID, measurement ID associated with the cell 505, or the physical cell ID of the cells 505) or according to an index associated with each cell 505 of the second set of cells 505 (e.g., an index of each cell in the CellsToAddModList of the MeasObjectNR information element).

In some examples, the control signaling 520 may include a flag that indicates for the UE 115-d to determine the priorities of the first and second set of cells 505 implicitly (e.g., according to the IDs).

As an illustrative example, in the case of L3 measurement-based mobility, the control signaling 520 (e.g., RRC message) may include measurement object information elements, report configuration information elements, and individual cell information elements. Accordingly, the UE 115-d may determine the measurement priority of the frequency, RAT, and cells 505 by the associated measurement ID or measurement object ID. In such examples, a smaller ID value may imply higher priority. Similarly, a smaller order index in the measurement ID list or measurement object ID list may imply higher priority. Among cells 505 associated with the same measurement ID or measurement object ID, the UE 115-d may determine the measurement priority of each cell 505 according to the order index in the cell list (e.g., CellsToAddModList) of the control signaling 520 (e.g., smaller order index implies higher priority).

As another illustrative example, in the case of L1 measurement-based mobility, the UE 115-d may determine the priorities of the cells 505 of each set of cells (e.g., for the uplink list of cells and the downlink list of cells) according to the candidate cell ID or the candidate configuration ID. For example, the control signaling 520 (in L1 measurement-based mobility) may include an LTM CSI resource configuration information element included within an LTM CSI report configuration information element, where the LTM CSI resource configuration information element indicates a candidate cell list (e.g., ltm-CandidateIdList). In such examples, the candidate cell list may include multiple candidate cell IDs (e.g., LTM-Candidate ID).

Accordingly, the UE 115-d may determine the measurement priority for each cell 505 of the first and second set of cells 505 (and associated frequency and RAT) according to the corresponding candidate cell ID or candidate configuration ID within the LTM candidate cell list. In such examples, a smaller ID value may imply higher priority. In some other examples, the UE 115-d may determine the measurement priority for each cell 505 of the first and second set of cells 505 according to the order index in the candidate cell list (e.g., ltm-CandidateIDList), where a smaller order index may imply higher priority.

In some examples, the UE 115-d may be provided, via the control signaling 520, a single priority for both uplink and downlink (e.g., either explicit or implicit). For example, instead of configuring separate priorities for both downlink and uplink, the network entity 105 may configure the UE 115-d with a single priority (and indicate via signaling, such as single bit field)) for the UE 115-d to follow the same priority order for both downlink and uplink measurement and target determination. In such examples, the UE 115-d may report different and separate target cells 505 and beams for uplink and downlink, where the UE 115-d may measure the uplink and downlink measurements of the cells 505 according to a same priority order.

As an illustrative example, the UE 115-d may receive, via the control signaling 520, a single set of candidate cells 505, where the single set of candidate cells 505 is associated with a single priority order. The control signaling 520 may also indicate a downlink quality metric, an uplink quality metric, a threshold quantity of uplink beams per cell 505 that are to satisfy the uplink quality metric, a threshold quantity of downlink beams per cell 505 that are to satisfy the downlink quality metric, a threshold quantity of cells to be reported, or any combination thereof.

Accordingly, the UE 115-d may obtain both uplink measurements and downlink measurements of beams of the cell 505-b of the single set of cells 505 with the highest priority. The UE 115-d may identify a first quantity of beams of the cell 505-b that have respective uplink measurements that satisfy the uplink quality metric. Additionally, the UE 115-d may identify a second quantity of beams of the cell 505-b that have respective downlink measurements that satisfy the downlink metric. If the identified first quantity of beams is greater than or equal to the threshold quantity of uplink beams and the identified second quantity of beams is greater than or equal to the threshold quantity of downlink beams the indicated via the control signaling 520, the UE 115-d may determine to report the cell 505-b via the mobility report 525. The UE 115-d may continue such a selection process until the UE 115-d selects a quantity of cells 505 from the single set of cells 505 that satisfies a threshold quantity of cells to be reported.

In such examples, if a downlink measurement of a cell 505 does not satisfy the downlink quality metric and the uplink measurement of the cell 505 does satisfy the uplink quality metric, the UE 115-d may move to the next highest priority cell 505 within the set of cells 505 for downlink metric measurement and potential selection. Similarly, if the downlink measurement of a cell 505 does satisfy the downlink quality metric but the uplink measurement of the cell 505 does not satisfy the uplink quality metric, the UE 115-d may move to the next highest priority cell for uplink metric measurement and potential selection.

In some examples, instead of providing the UE 115-d with measurement priorities, the UE 115-d may receive, via the control signaling 520, separate scaling factors, separate offsets, or both (e.g., one for uplink and one for downlink) associated with the measured metric per cell 505, per measured frequency, per TRP for the UE 115-d to rank the cells 505 (or the beams or the TRPs) in the mobility report 525.

In such examples, the same scaling factor or offset may be indicated per cell 505 or per cells 505 within an associated frequency. In this way, the measured metric (e.g., RSRP, SINR, RSRQ) may be multiplied with the scaling factor (between 0 and 1) or added with an offset, with the value specified as a function of the parameters of cell 505. Accordingly, a higher value for larger cell 505 (e.g., larger bandwidth part) may be obtained, while a lower value for a higher load may be obtained. The UE 115-d may report a threshold quantity of cells 505 (or beams of the cells) in the mobility report 525 by ranking the cells 505 (or beams) according to the corresponding adjusted metrics.

As an illustrative example, the UE 115-d may receive, via the control signaling 520, a set of cells 505 for the mobility procedure, where each cell 505 may be associated with a respective downlink scaling factor (or offset) and a respective uplink scaling factor (or offset). The UE 115-d may obtain, per cell 505 or per beam per cell 505, a respective uplink measurement and a respective downlink measurement. As such, the UE 115-d may apply the respective uplink scaling factor (or offset) to the respective uplink measurement for the cell 505-b to obtain a first adjusted metric for the cell 505-b. Similarly, the UE 115-d may apply the respective downlink scaling factor to the respective downlink measurement of the cell 505-b to obtain a second adjusted metric for the cell 505-b. The UE 115-d may obtain the first and second adjusted metrics for each cell 505 within the set of cells 505 and proceed to rank the cells 505 according to the values of the first and second adjusted metrics. The UE 115-d may report a subset of the set of cells 505 via the mobility report 525 through the uplink 515-a, where first and second adjusted metrics of each of the subset of cells 505 satisfied a threshold (e.g., were the top beams/cells).

In some examples, the control signaling 520 may indicate a first set of cells 505 for uplink communications and a second set of cells 505 for downlink communications, where the UE 115-d may receive an explicit indication of the measurement priority for the first set of cells 505 and implicitly determine the measurement priority for the second set of cells 505.

In some other examples, the control signaling 520 may indicate a first set of cells 505 for uplink communications and a second set of cells 505 for downlink communications, where the UE 115-d may receive an explicit indication of the measurement priority for the second set of cells 505 and implicitly determine the measurement priority for the first set of cells 505.

In some examples, the control signaling 520 may indicate a first set of cells 505 for uplink communications and a second set of cells 505 for downlink communications, where the UE 115-d may identify the measurement priority for the first set of cells 505 implicitly or explicitly and receive a scaling factor (or offset) for downlink priority determination for the second set of cells 505.

In some other examples, the control signaling 520 may indicate a first set of cells 505 for uplink communications and a second set of cells 505 for downlink communications, where the UE 115-d may identify the measurement priority for the second set of cells 505 implicitly or explicitly and receive a scaling factor (or offset) for uplink priority determination for the first set of cells 505.

In some examples, the control signaling 520 may indicate a first set of cells 505 for uplink communications and a second set of cells 505 for downlink communications, where the UE 115-d may receive a scaling factor (or offset) for uplink priority determination for the first set of cells 505 and receive a scaling factor (or offset) for downlink priority determination for the second set of cells 505.

In some examples, the UE 115-d may receive separate additional assistance information to enable the UE 115-d to estimate uplink performance and downlink performance per cell 505, per measured frequency, or per TRP.

By implementing the techniques described herein, the UE 115-d may report, via the mobility report 525, a first set of cells 505 that have uplink measurements that satisfy uplink quality metrics and report a second set of cells 505 that have downlink measurements that satisfy downlink quality metrics, thereby ensuring that cell selection may include a first cell 505 that satisfies uplink considerations and include a second cell 505 that satisfies downlink considerations. Accordingly, the UE 115-d may perform the mobility procedure to communicate with the cell 505-b for downlink communications and perform the mobility procedure to communicate with the cell 505-c for uplink communications, where the cell 505-b and the cell 505-c may be selected from the cells 505 reported via the mobility report 525. As described herein, the UE 115-d may transmit the mobility report 525 according to one of the report formats further described herein with reference to FIGS. 7A through 7E.

FIG. 6 shows an example of a process flow 600 that supports cell selection in wireless communications systems in accordance with one or more aspects of the present disclosure. Aspects of the process flow 600 may implement, or be implemented by, aspects of the wireless communications system 100, the wireless communications system 200, the wireless communications system 300, the process flow 400, and the wireless communications system 500 as described herein with reference to FIGS. 1 through 5. For example, the process flow 600 may include a UE 115-e, a cell 605-a, and a cell 605-b, which may be examples of corresponding devices as described herein. The techniques described in the context of the process flow 600 may enable the UE 115-e to measure, report, and/or select a first cell 605 for uplink communications and a second cell 605 for downlink communications according to uplink measurements, downlink measurements, or both.

At 610, the UE 115-e may receive control signaling indicating a set of cells 605 (e.g., via a cell list) associated with mobility at the UE 115-e (e.g., one or more mobility procedures, LTM procedures, or the like). For example, the UE 115-e may be connected to the cell 605-a and receive the control signaling from the cell 605-a (e.g., from the network entity 105 operating the cell 605-a).

In some implementations, the control signaling may include an indication of a downlink measurement priority order for each cell 605 of the set of cells 605, an uplink measurement priority order for each cell 605 of the set of cells 605, a single priority order for both downlink and uplink for each cell 605 of the set of cells 605, or any combination thereof. Additionally, or alternatively, the control signaling may include an indication of one or more measurement IDs, one or more measurement object IDs, one or more cell configuration IDs, or any combination thereof. The control signaling may further indicate a report configuration associated with the one or more mobility procedures.

In some examples, in response to receiving the control signaling, the UE 115-e may determine a downlink priority order, an uplink priority order, or both based on one or more IDs associated with each cell 605 of the set of cells 605 or based on an index value of each cell 605 of the set of cells 605 (e.g., implicit determination). For example, the UE 115-e may determine the downlink priority order, the uplink priority order, or both based on one or more IDs associated with each cell 605 of the set of cells 605 indicated by the control signaling of 605 (e.g., one or more measurement IDs, one or more measurement object IDs, one or more cell 605 configuration IDs, or the like).

Additionally, or alternatively, (e.g., when a subset of cells 605 of the set of cells 605 may be associated with one or more same IDs, among other examples) the UE 115-e may determine the uplink priority order, the downlink priority order, or both based on an index value associated with each cell 605 of the set of cells 605. Accordingly, the UE 115-e may identify an index value for each cell 605 corresponding to one or more lists (e.g., cell 605 list, or cell 605 list), and the UE 115-e may determine a respective priority (e.g., downlink, uplink, or both) based on the index value. In some examples, the network entity 105 may indicate for the UE 115-e to determine (e.g., implicitly determine) the downlink priority order, the uplink priority order, or both based on one or more flags included within the control signaling of 605.

At 615, the UE 115-e may receive one or more reference signals from each of the set of cells 605. For example, the UE 115-e may receive a respective reference signal from one or more beams of the cell 605-b. In some examples, the reference signals may be CSI-RSs, pathloss reference signals, or both.

At 620, the UE 115-e may obtain one or more measurements associated with one or more cells 605 of the set of cells 605. For example, the UE 115-e may perform measurements of each cell 605 of the set of candidate of cells 605 according to the downlink priority (e.g., the downlink priority, or the single priority) to obtain a downlink metric associated with each cell 605, and the UE 115-e may additionally perform one or more measurements of each cell 605 of the set of candidate of cells 605 according to the uplink priority (e.g., the uplink priority, or the single priority) to obtain an uplink metric associated with each cell 605.

In some examples, the downlink metric, the uplink metric, or both may satisfy one or more respective quality thresholds (e.g., threshold condition, or quality check), where the respective quality thresholds may be indicated by the control signaling of 605. Additionally, or alternatively, the UE 115-e may perform one or more additional measurements of each cell 605 the set of cells 605 (e.g., for downlink metrics, for uplink metrics, or both) until a quantity of cells 605 satisfying the respective quality thresholds satisfies a threshold reporting quantity.

In some examples, the control signaling of 605 may further include an indication of one or more respective scaling factors, respective offset values, or both, where the scaling factors, the offset values, or both may be based on one or more cell parameters for each cell 605. Accordingly, the UE 115-e may obtain (e.g., via performing one or more measurements) a downlink metric for each cell 605 of the set of cells 605, an uplink metric for each cell 605 of the set of cells 605, or both. In such examples, the UE 115-e may apply a respective scaling factor, a respective offset value, or both for each downlink measurement, and the UE 115-e may additionally apply a respective scaling factor, a respective offset value, or both for each uplink measurement. Accordingly, an ordering (e.g., ranking) of the set of cells 605 for reporting may be based on an ordering of resulting adjusted metrics associated with each cell 605 of the set of cells 605.

At 625, the UE 115-e may generate and transmit (and the network entity 105 may obtain) a mobility report. In some examples, the mobility report may include an indication a first subset of cells 605 associated with downlink communications based on the downlink measurements of each cell 605 of the first subset of cells 605 satisfying a respective downlink quality threshold. The mobility report may also include a second subset of cells 605 associated with uplink communications based on the uplink measurements of each cell 605 of the first subset of cells 605 satisfying a respective uplink quality threshold.

In some examples, one or more cells 605 of the first subset of cells 605 may be the same as one or more cells 605 of the second subset of cells 605 (e.g., one or more cells 605 may satisfy both downlink and uplink quality thresholds). In some examples, an ordering (e.g., ranking) of the set of cells 605 included within the mobility report may be associated with the respective priorities (e.g., for downlink or for uplink), the adjusted metrics, or the like.

At 630, the UE 115-e may communicate with a first cell 605 (e.g., in accordance with a mobility procedure). For example, the UE 115-e may perform downlink communications with the first cell 605 based on the first cell 605 being included within the first subset of cells 605 of the mobility report (e.g., satisfying the downlink quality threshold). Additionally, or alternatively, the UE 115-e may communicate with the first cell 605 based on a ranking of the first cell 605 within the mobility report (e.g., the first cell 605 may be a highest-ranked cell 605 of the first subset of cells 605).

At 635, the UE 115-e may communicate with a second cell 605 (e.g., in accordance with the mobility procedure). For example, the UE 115-e may perform uplink communications with the second cell 605 based on the second cell 605 being included within the second subset of cells 605 of the mobility report (e.g., satisfying the uplink quality threshold). Additionally, or alternatively, the UE 115-e may communicate with the second cell 605 based on a ranking of the second cell 605 within the mobility report (e.g., the second cell 605 may be a highest-ranked cell 605 of the second subset of cells 605).

FIGS. 7A through 7E show examples of report formats 700, 701, 702, 703, and 704 that support cell selection in wireless communications systems in accordance with one or more aspects of the present disclosure. Aspects of the report formats 700, 701, 702, 703, and 704 may implement, or be implemented by, aspects of the wireless communications system 100, the wireless communications system 200, the wireless communications system 300, the process flow 400, the wireless communications system 500, and the process flow 500 as described herein with reference to FIGS. 1 through 6. For example, the report formats 700, 701, 702, 703, and 704 may be utilized by a UE 115 to report a subset of a set of cells for mobility (e.g., candidate cells).

In some cases, the UE 115 may implement mechanisms and procedures for L1 and L2 based inter-cell mobility for mobility latency reduction. For example, the UE 115 may support configuration and maintenance for multiple candidate cells to allow for relatively quicker application of configurations for candidate cells. Further, the UE 115 may support a dynamic switch mechanism among candidate serving cells (including primary cells and secondary cells) for the potential applicable scenarios based on L1 and L2 signaling. The UE 115 may also support L1 enhancements for inter-cell beam management, including L1 measurement and reporting, and beam indication and support enhancements to timing advance management, CU-DU interface signaling to support L1 and L2 mobility, FR2 enhancements, among other examples. The UE 115 may also support L1 and L2 based inter-cell mobility in standalone scenarios (e.g., carrier aggregation and NR-DC case with serving cell change within one configured grant), in intra-DU case and intra-CU inter-DU cases (e.g., applicable for Standalone and carrier aggregation), for both intra-frequency and inter-frequency, for both FR1 and FR2, and in cases in which the source and target cells may be synchronized or non-synchronized.

As part of LTM, a network entity (e.g., such as the network entity 105) may configure (e.g., indicate) the UE 115 (e.g., such as the UE 115) to measure different cells (e.g., handover candidate cells), which may be at different frequencies. Accordingly, in the mobility report, the UE 115 may report L cells (e.g., where L is equal to 1, 2, 3, 4, or more cells). In some cases, the quantity of cells to be reported, L, may be based on a UE capability (e.g., a capability of the UE 115). Additionally, or alternatively, the UE 115 may determine which cells to include within the cell measurement report (e.g., which cells to be reported is up to UE implementation).

In some cases, a mobility report (e.g., a cell report or beam report), may include one or more downlink metrics and may refrain from including uplink metrics. Accordingly, a selected cell or beam (e.g., a cell or beam selected based on a downlink metric) may be unsuitable for uplink communications (e.g., incapable of supporting uplink performance). For example, in some cases, selecting a target cell, a target beam, a target TRP, or the like offering a relatively high downlink throughput (e.g., suitable downlink throughput of a set of available cells) may not guarantee a correspondingly high uplink throughput (e.g., suitable uplink throughput of a set of available cells). For example, an uplink transmission power may be different across different cells, beams, TRPs, or the like.

As such, it may be desirable to select separate target cells (e.g., separate target beams, TRPs) for downlink and uplink communications. That is, picking a target cell offering improved downlink throughout may not guarantee an improved uplink throughput. Accordingly, by providing separate downlink and uplink target cells, and associated metrics (e.g., measurements) in a mobility report may be desirable.

For example, an MPE factor may be applied to a target cell selected for downlink (e.g., MPE issue in suitable downlink cell), while an MPE factor may be absent from a different cell that provides relatively high uplink performance (e.g., no MPE issue in a different cell that is suitable for uplink). Additionally, or alternatively, an uplink transmission power for the target cell selected for downlink may be lower than a downlink transmission power due to power sharing with other FRs or RATs for the selected cell (e.g., LTE/4G connection and 5G FR1 is overlapping with the suitable downlink cell). However, if another cell that is well-separated (e.g., separated in distance, or isolated, among other examples) from an overlapping band is present (e.g., a well-separated cell supported by a dedicated power amplifier and not sharing uplink transmission power), the well-separated cell may be preferred for uplink (e.g., while being unsuited for downlink communications). Additionally, or alternatively, one or more cells of the set of cells may be uplink-only TRPs, or uplink-only cells (e.g., cells that are unsuitable for downlink communications).

In some other cases, a cell load, available resources (e.g., time domain or frequency domain resources), transmission or reception capabilities, or available hardware, among other examples, may be different for downlink communications and uplink communications in a given cell. In TDD, a slot or symbol pattern, a quantity of uplink or downlink layers, respective downlink or uplink bandwidth, or the like, may lead to asymmetric uplink and downlink performance after a cell handover procedure (e.g., cell switch). In FDD, a cell bandwidth for downlink and uplink, or time resources, frequency resources, or spatial resources for uplink could be different from time resources, frequency resources, or spatial resources for downlink. Additionally, or alternatively, a target cell may have a higher downlink load (e.g., downlink traffic load) than an uplink load, and the uplink load, the downlink load, or both may vary dynamically (e.g., vary with time), which may lead to relatively poor quality of service (QoS) after a cell handover procedure. In such cases, additional signaling may be included (e.g., between the network and a UE) for the UE to estimate downlink and uplink throughput individually, which may increase signaling overhead.

Additionally, or alternatively, a downlink pathloss may vary from an uplink pathloss. For example, a downlink may have a reduced pathloss compared to an uplink when performing FDD communications. In such cases, determining a cell for uplink based on a downlink metric may be ineffective.

In some cases, a UE 115 may perform downlink communications with a first cell and may perform uplink communications with a second cell. In some cases, a UE may operate within a coverage area for one downlink and uplink TRP as well as multiple uplink-only TRPs (e.g., to support coverage extension). In some cases, each uplink-only TRP may support limited (e.g., thin) downlink capabilities (e.g., SSB or CSI-RS for TRP measurement). In such cases, the UE may identify (e.g., determine or detect) an uplink-only TRP based on one or more corresponding downlink reference signal measurements. For example, the UE may determine and report an uplink performance of the uplink-only TRP based on one or more downlink metrics.

In some cases, one or more LTM report formats correspond to target cells or TRPs having downlink and uplink capabilities. For example, an LTM report may include downlink metrics. Accordingly, a network entity (e.g., based on receiving the LTM report including the downlink metrics) may be unable to accurately identify (e.g., determine or detect) a target cell or TRP for uplink communications (e.g., the network entity may be unable to determine uplink performance from downlink metrics).

The techniques, methods, and devices described herein may support formats for mobility reports 705 (e.g., LTM L1 formats). In some examples, the UE 115 may identify and report one or more cells that may be suitable for uplink communications and one or more cells that may be suitable for downlink communications (e.g., a target cell that may be separate for uplink and downlink). For example, the UE may identify and report a first cell suitable for downlink communications and a second cell suitable for uplink communications. Additionally, or alternatively, the UE may identify and report a cell suitable for downlink and uplink communications.

In some implementations, for LTM (e.g., L1 or L2-triggered mobility) or L3-triggered mobility, a network entity may provide (e.g., indicate via control signaling, such as RRC signaling) one or more configuration parameters per each cell of a set of candidate cells, per measured frequency, or per TRP. Accordingly, the UE may estimate (e.g., measure, determine, or derive, among other examples) and report an uplink metric for each cell. That is, the UE 115 may receive control signaling that indicates a set of cells associated with mobility at the UE 115, where the control signaling further indicates a set of parameters associated each cell of the set of cells. In such examples, each of the cells (e.g., frequencies or TRPs) may be dedicated for uplink communications or be dedicated for both uplink and downlink communications.

A respective set of parameters may enable the UE 115 to estimate an uplink performance (e.g., via one or more uplink metrics) for the corresponding cell. For example, the set of parameters for a first cell may include a first bandwidth, a first offset in transmission power, a first pathloss metric, a first load indicator (e.g., traffic load), a first percentage of utilization (e.g., a percentage of utilized resources), a first quantity of active connections (e.g., uplink connections, downlink connections, or both), among other examples.

As such, using the respective set of parameters for each cell of the set of cells, the UE 115 may determine an uplink metric for each cell of the set of cells. In such examples, the uplink metric may include an uplink RSRP. In some examples, the UE 115 may determine the uplink RSRP based on one or more downlink reference signals (e.g., corresponding to an uplink reference signal), where the UE 115 may derive the uplink RSRP based on the downlink reference signal. For example, the downlink reference signal may be QCLed with an uplink reference signal (e.g., QCL with the uplink reference signal based on corresponding to a same TCI state as the uplink reference signal).

Accordingly, the UE 115 may first receive the downlink reference signal and measure the downlink RSRP of the downlink reference signal. The UE 115 may further determine the uplink RSRP based on a difference between a configured uplink transmission power (uplink Tx power) (e.g., indicated to the UE 115 via the control signaling), the downlink RSRP, and a downlink RSRP offset value (e.g., uplink RSRP=uplink Tx power−downlink RSRP+offset). In some examples, the network entity 105 may configure the offset value to compensate for a difference between a downlink transmission power and an uplink transmission power (e.g., the downlink transmission power).

Additionally, or alternatively, the UE 115 may determine the uplink RSRP value based on a pathloss reference signal that corresponds to an uplink reference signal of the UE 115 (e.g., the downlink reference signal may be the path loss reference signal for the uplink reference signal). Accordingly, the UE 115 may first identify the downlink pathloss of the channel between the UE 115 and the cell via the pathloss reference signal. The UE 115 may derive the uplink RSRP value based on the downlink pathloss. For example, the UE 115 may derive the uplink RSRP according to a difference between a configured uplink transmission power (e.g., indicated via the control signaling) and the pathloss value (e.g., uplink RSRP=UL Tx power−PathLoss).

In such examples, the UE 115 may determine an uplink RSRP for multiple beams of each cell of the set of cells. For example, if a first cell is associated with five beams, the UE 115 may receive one or more reference signals from the five beams and determine a respective uplink RSRP for each of the five beams.

In some implementations, based on determining the one or more uplink metrics associated with the set of cells, the UE may transmit a mobility report 705 including an indication of one or more downlink metrics, the one or more uplink metrics, or both associated with at least a subset of cells of the set of cells. The network entity may indicate a format of the mobility report 705 via the control signaling.

For example, with respect to the report format 700, the UE 115 may output the mobility report 705-a according to the report format 700. In such examples (e.g., for LTM), the network entity 105 may indicate, via the control signaling, for the UE 115 to report one or more uplink metrics for a quantity of cells, L, where L is an integer quantity of cells (e.g., report L cells along with uplink metric).

In such examples, the UE 115 may transmit, via the mobility report 705-a, uplink RSRP values for L cells of the set of cells, where the UE 115 may select the L cells from the set of cells according to the uplink RSRP values (e.g., the highest relative RSRP values). Further, the UE 115 may report, via the mobility report 705-a, uplink RSRPs for a quantity of measured beams, M, where M is an integer quantity of beams. Accordingly, the UE 115 may include, within the mobility report 705-a, a total quantity of beams (e.g., reported beams) corresponding to the product of M and L (e.g., M×L beams). That is, the UE 115 may report a respective uplink RSRP for M beams of each cell of the L cells in the mobility report 705-a. As an illustrative example, for a first cell (e.g., Cell 1), the UE 115 may report the uplink RSRP values for M beams of the first cell. As such, each entry of the mobility report 705-a may be identified according to a cell ID and a beam ID.

In some other implementations, with respect to the report format 701, the UE 115 may output the mobility report 705-b (e.g., mobility report) according to the report format 701. In such examples (e.g., for LTM procedures), the network entity 105 may indicate, via the control signaling, for the UE 115 to report one or more uplink metrics for a first quantity of cells, N1, and report one or more downlink metrics for a second quantity of cells, N2, where N1 and N2 are integer quantities of cells (e.g., report N1 cells along with uplink metric and N2 cells along with downlink metrics).

In such implementations, the cells included for uplink metric reporting and the cell included for downlink metric reporting may be different cells. Additionally, or alternatively, one or more of the cells included for uplink metric reporting may be the same cells as one or more cells included for downlink metric reporting. In some examples, N1 and N2 may be a same quantity (e.g., equivalent quantities), or different quantities.

The UE 115 may include a quantity of beams reported per cell (e.g., M) for the cells included for uplink reporting and the cells included for downlink reporting. Additionally, or alternatively, the UE may include a first quantity of M1 beams for each cell included for uplink reporting and a second quantity of M2 beams for each cell included for downlink reporting. Accordingly, the UE may include, within the mobility report 705-b, a total quantity of beams (e.g., reported beams) corresponding to M×N1+M×N2 beams, or M1×N1+M2×N2 beams. As an illustrative example, the UE 115 may receive, via the control signaling, an indication to report the uplink RSRP for 4 beams (M1=4) of 3 cells (N1=3) and to report the downlink RSRP for 2 beams (M2=2) of 2 cells (N2=2). Accordingly, the UE 115 may report a total of 16 beams in the mobility report 705-b.

With respect to the report formats 702 and 703, the network entity 105 may indicate (e.g., configure), via control signaling, for the UE 115 to report one or more uplink metrics and one or more downlink metrics for a quantity of cells, N (e.g., report N cells along with both uplink metric and downlink metric). In such examples, a quantity of beams reported per cell (e.g., M) may be the same for both uplink and downlink metrics, where M may be indicated via the control signaling. In some other examples, the UE 115 may be indicated to report the uplink metric for a first quantity of beams (e.g., M1) per cell and report the downlink metric for a second quantity of beams (e.g., M2) per cell, where M1 and M2 may be received via the control signaling.

In some examples, the UE 115 may report the uplink RSRP for a different set of beams for candidate cell as compared to the downlink RSRP. For example, the UE 115 may receive an indication to report the uplink metric for a first M beams and report the downlink metric for a second M beams for each cell of N cells. Accordingly, with respect to the report format 702, the UE 115 may transmit the mobility report 705-c, where the mobility report 705-c may indicate, per each cell of the N cells, the uplink RSRP for beams a1 through aM and the downlink RSRP for beams b1 through bM. As such, the total quantity of entries (e.g., total quantity of beams) reported in the mobility report 705-c may be 2M×N.

In some other examples, the UE 115 may report the uplink RSRP for the same set of beams for a candidate cell as compared to the downlink RSRP. That is, the UE 115 may receive an indication to report the uplink and downlink metric for the same M beams of N candidate cells. Accordingly, with respect to the report format 703, the UE 115 may transmit the mobility report 705-d, where the mobility report 705-d may include the uplink and downlink RSRPs for beams 1 through M of each N cells. In such examples, the total quantity of entries (e.g., total quantity of reported beams) in the mobility report 705-d may be MxN beams with two metrics per beam.

With respect to the report format 704, the UE 115 may output the mobility report 705-e according to the report format 704. In such examples, the network entity 105 may indicate, via the control signaling, for the UE 115 to report the uplink or downlink metric for a quantity of beams (e.g., M beams) for each of a quantity of cells (e.g., L cells). That is, the UE 115 may report L cells along with either the uplink metric or the downlink metric for M beams per cell.

To differentiate between whether the UE 115 is reporting the uplink metric or the downlink metric for a beam, the UE 115 may include an additional bit (e.g., a most significant bit (MSB) or a least significant bit (LSB)) within the payload of each entry of the mobility report 705-e, where the additional bit may indicate whether the metric reported for each of the beams is the uplink RSRP or the downlink RSRP (e.g., bit=1 indicates an uplink metric, and bit=0 indicates a downlink metric, or vice versa). Additionally, or alternatively, the UE 115 may transmit the indication via control signaling (e.g., reserved UCI bits).

Accordingly, the UE 115 may include, within the mobility report 705-e, a total quantity of beams (e.g., reported beams) corresponding to the product of M and L (e.g., M×L beams). As an illustrative example, the UE 115 may receive an indication to report the uplink RSRP or the downlink RSRP for 4 beams (e.g., M=4) across 3 cells (e.g., L=3). Accordingly, the UE 115 may report, via the mobility report 705-e, the uplink RSRP or the downlink RSRP for 12 beams total.

In some implementations, the UE may output one or more LTM reports according to a payload size and quantization rule. For example, the UE may include a largest reported RSRP value (e.g., largest RSRP value of the reported downlink RSRP values and the reported uplink RSRP values) within the mobility report as an absolute value, and one or more additional (e.g., different) RSRP values as differential values (e.g., percentages or fractions) compared to the absolute value. As an illustrative example, if the largest RSRP value is 5 and the second largest RSRP value is 4, the UE 115 may report the second largest RSRP value as being −1 (e.g., 4−5=−1), such that the network entity 105 may have an indication that the second largest RSRP value is different from the largest RSRP value by −1.

Additionally, or alternatively, the UE 115 may include, within the LTM report, a largest downlink RSRP value (e.g., largest downlink RSRP value of the reported downlink RSRP values) and the largest uplink RSRP value (e.g., largest uplink RSRP value of the reported uplink RSRP values) as absolute values, and one or more additional (e.g., different) downlink RSRP values and uplink RSRP values as differential values (e.g., percentages or fractions) compared to the respective absolute values (e.g., differential reports relative to respective downlink or uplink values). Accordingly, the UE may utilize separate quantization, step sizes, reporting ranges, or the like for downlink and uplink reports.

As an illustrative example, if the largest downlink RSRP value is 5 and the second largest downlink RSRP value is 4, the UE 115 may report the second largest downlink RSRP value as being −1 (e.g., 4−5=−1), such that the network entity 105 may have an indication that the second largest downlink RSRP value is different from the largest downlink RSRP value by −1. Similarly, if the largest uplink RSRP value is 3 and the second largest uplink RSRP value is 1, the UE 115 may report the second largest uplink RSRP value as being −2 (e.g., 1−3=−2), such that the network entity 105 may have an indication that the second largest uplink RSRP value is different from the largest uplink RSRP value by −2.

In some implementations, the UE 115, the network entity 105, or both may support prediction-based techniques for beam reporting (in addition to or rather than measured values). For example, the UE 115, the network entity 105, or both may obtain one or more inputs, such as an indication of an MPE behavior per downlink beam, downlink beam pattern information of a network entity 105 (e.g., if different from downlink beam), uplink interference, uplink noise, downlink transmission power, downlink cell load (e.g., downlink traffic load), or the like. Accordingly, the UE, the network entity, or both may predict (e.g., estimate, or anticipate, among other examples) the beam or cell for the mobility procedure or obtain the uplink or downlink metrics for a beam or cell for uplink communications according to the one or more inputs.

The techniques, methods, and devices described herein may support LTM procedures (e.g., L1/L2-triggered mobility procedures), as well as additional cell reporting procedures including L3 RRC report, L2 MAC control element (MAC-CE) reports, event-triggered L1, L2, or L3 reports, or the like.

FIG. 8 shows an example of a process flow 800 that supports cell selection in wireless communications systems in accordance with one or more aspects of the present disclosure. Aspects of the process flow 800 may implement, or be implemented by, aspects of the wireless communications system 100, the wireless communications system 200, the wireless communications system 300, the process flow 400, the wireless communications system 500, the process flow 600, the report format 700, the report format 701, the report format 702, the report format 703, and the report format 704. For example, the process flow 800 may include a UE 115-f, a cell 805-a, and a cell 805-b, which may be examples of corresponding entities as described herein. The techniques described in the context of the process flow 800 enables the UE 115-f to transmit a mobility report according to one or more formats.

At 810, the UE 115-f may receive control signaling indicating a set of cells 805 (e.g., candidate cells) associated with a mobility procedure of the UE 115-f. The control signaling may additionally include an indication of a reporting format for a mobility report (e.g., LTM report) associated with the mobility procedure, an indication of a set of parameters (e.g., a cell bandwidth, a transmission power offset value, a pathloss metric, traffic load information, resource utilization, a quantity of active downlink or uplink connections, or the like) associated with one or more measurements of each cell 805 of the set of cells 805, or both.

At 815, the UE 115-f may receive a reference signal (e.g., pathloss reference signal or CSI-RS) from one or more cells 805 of the set of cells 805. For example, the cell 805-b may transmit one or more reference signals to the UE 115-f.

At 820, the UE 115-f may obtain a downlink metric, an uplink metric, or both associated with each cell 805 of the set of cells 805 based on receiving the one or more reference signals (e.g., from each cell 805 of the set of cells 805). For example, based on receiving the reference signals, the UE 115-f may perform one or more measurements. Accordingly, the UE 115-f may determine a downlink metric (e.g., downlink RSRP) associated with each cell 805 of the set of cells 805. In some examples, the UE 115-f may obtain the downlink metric based on one or more parameters of the set of cells 805 configuration parameters indicated by the control signaling.

In some examples, the UE 115-f may derive (e.g., compute, calculate, or determine, among other examples) an uplink metric (e.g., uplink RSRP) for each cell 805 of the set of cells 805 based on the downlink metric and the set of parameters indicated by the control signaling of 805. For an example, using the reference signal received from the cell 805-b, the UE 115-f may determine (e.g., identify, detect, or calculate, among other examples) a downlink RSRP value. Accordingly, the UE 115-f may determine an uplink RSRP for the corresponding cell 805 based on an offset value (e.g., a transmission power offset) indicated by the control signaling.

Additionally, or alternatively, the UE 115-f may derive (e.g., compute, calculate, or determine, among other examples) an uplink metric for each cell 805 of the set of cells 805 based on one or more pathloss reference signals. For example, using the pathloss reference signal received from the cell 805-b, the UE 115-f may determine (e.g., measure, identify, detect, or calculate, among other examples) a downlink pathloss metric for the cell 805-b. Accordingly, the UE 115-f may derive an uplink metric (e.g., uplink RSRP) for the cell 805-b based on the downlink pathloss and an uplink transmission power parameter indicated by the control signaling. For example, the uplink RSRP may be the difference between the uplink transmission power and the determined downlink pathloss (e.g., pathloss).

At 825, the UE 115-f may transmit (e.g., and the network entity 105 may obtain) a mobility report (e.g., LTM report) including an indication of at least a subset of cells 805 of the set of cells 805. The mobility report may include at an indication of at least one of the one or more downlink metrics, the one or more uplink metrics, or both associated with each cell 805 of the subset of cells 805. The UE 115-f may transmit the mobility report according to one or more report formats further described herein with reference to FIGS. 7A through 7E. At 830, the UE 115-f may communicate with a cell 805 identified from the mobility report based on performing the mobility procedure to the identified cell 805.

FIG. 9 shows a block diagram 900 of a device 905 that supports cell selection in wireless communications systems in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to cell selection in wireless communications systems). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to cell selection in wireless communications systems). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of cell selection in wireless communications systems as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving control signaling that identifies a set of candidate cells associated with a mobility procedure at the UE, where the control signaling indicates a quality metric associated with a first communication link between the UE and the set of candidate cells. The communications manager 920 is capable of, configured to, or operable to support a means for obtaining, for one or more candidate cells of the set of candidate cells, a respective first measurement corresponding to the first communication link and a respective second measurement corresponding to a second communication link between the UE and the set of candidate cells. The communications manager 920 is capable of, configured to, or operable to support a means for transmitting a mobility report that indicates a subset of candidate cells of the set of candidate cells in accordance with the obtaining, where the respective first measurement of each candidate cell of the subset of candidate cells satisfies the quality metric.

Additionally, or alternatively, the communications manager 920 may support wireless communications in accordance with examples as disclosed herein. For example, the communications manager 920 is capable of, configured to, or operable to support a means for receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. The communications manager 920 is capable of, configured to, or operable to support a means for obtaining a respective first measurement associated with the first communication link for the first set of candidate cells in accordance with the respective first priorities. The communications manager 920 is capable of, configured to, or operable to support a means for obtaining a respective second measurement associated with the second communication link for the second set of candidate cells in accordance with the respective second priorities. The communications manager 920 is capable of, configured to, or operable to support a means for transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

Additionally, or alternatively, the communications manager 920 may support wireless communications in accordance with examples as disclosed herein. For example, the communications manager 920 is capable of, configured to, or operable to support a means for receiving control signaling that indicates a set of candidate cells associated with a mobility procedure at the UE, where the control signaling identifies a respective set of parameters associated with measurements of a first communication link for each candidate cell of the set of candidate cells. The communications manager 920 is capable of, configured to, or operable to support a means for obtaining respective first measurements associated with the first communication link for each candidate cell of the set of candidate cells according to the respective sets of parameters. The communications manager 920 is capable of, configured to, or operable to support a means for obtaining respective second measurements associated with a second communication link for each candidate cell of the set of candidate cells in accordance with the control signaling. The communications manager 920 is capable of, configured to, or operable to support a means for transmitting a mobility report that indicates a subset of candidate cells of the set of candidate cells and indicates at least the respective first measurements associated with one or more candidate cells of the subset of candidate cells.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and reduced power consumption, more efficient utilization of communication resources, among other advantages.

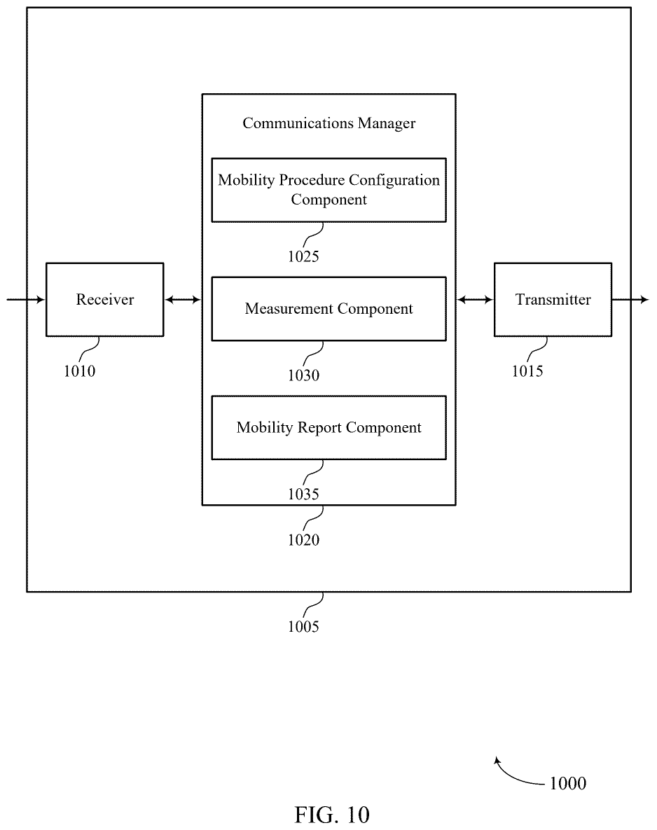

FIG. 10 shows a block diagram 1000 of a device 1005 that supports cell selection in wireless communications systems in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to cell selection in wireless communications systems). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to cell selection in wireless communications systems). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of cell selection in wireless communications systems as described herein. For example, the communications manager 1020 may include a mobility procedure configuration component 1025, a measurement component 1030, a mobility report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The mobility procedure configuration component 1025 is capable of, configured to, or operable to support a means for receiving control signaling that identifies a set of candidate cells associated with a mobility procedure at the UE, where the control signaling indicates a quality metric associated with a first communication link between the UE and the set of candidate cells. The measurement component 1030 is capable of, configured to, or operable to support a means for obtaining, for one or more candidate cells of the set of candidate cells, a respective first measurement corresponding to the first communication link and a respective second measurement corresponding to a second communication link between the UE and the set of candidate cells. The mobility report component 1035 is capable of, configured to, or operable to support a means for transmitting a mobility report that indicates a subset of candidate cells of the set of candidate cells in accordance with the obtaining, where the respective first measurement of each candidate cell of the subset of candidate cells satisfies the quality metric.

Additionally, or alternatively, the communications manager 1020 may support wireless communications in accordance with examples as disclosed herein. The mobility procedure configuration component 1025 is capable of, configured to, or operable to support a means for receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. The measurement component 1030 is capable of, configured to, or operable to support a means for obtaining a respective first measurement associated with the first communication link for the first set of candidate cells in accordance with the respective first priorities. The measurement component 1030 is capable of, configured to, or operable to support a means for obtaining a respective second measurement associated with the second communication link for the second set of candidate cells in accordance with the respective second priorities. The mobility report component 1035 is capable of, configured to, or operable to support a means for transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

Additionally, or alternatively, the communications manager 1020 may support wireless communications in accordance with examples as disclosed herein. The mobility procedure configuration component 1025 is capable of, configured to, or operable to support a means for receiving control signaling that indicates a set of candidate cells associated with a mobility procedure at the UE, where the control signaling identifies a respective set of parameters associated with measurements of a first communication link for each candidate cell of the set of candidate cells. The measurement component 1030 is capable of, configured to, or operable to support a means for obtaining respective first measurements associated with the first communication link for each candidate cell of the set of candidate cells according to the respective sets of parameters. The measurement component 1030 is capable of, configured to, or operable to support a means for obtaining respective second measurements associated with a second communication link for each candidate cell of the set of candidate cells in accordance with the control signaling. The mobility report component 1035 is capable of, configured to, or operable to support a means for transmitting a mobility report that indicates a subset of candidate cells of the set of candidate cells and indicates at least the respective first measurements associated with one or more candidate cells of the subset of candidate cells.

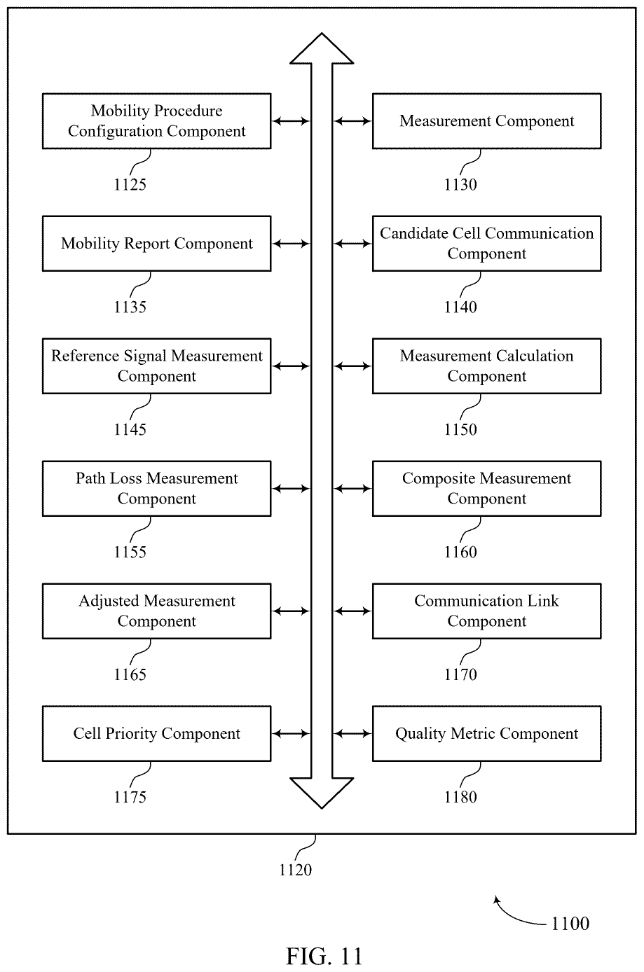

FIG. 11 shows a block diagram 1100 of a communications manager 1120 that supports cell selection in wireless communications systems in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of cell selection in wireless communications systems as described herein. For example, the communications manager 1120 may include a mobility procedure configuration component 1125, a measurement component 1130, a mobility report component 1135, a candidate cell communication component 1140, a reference signal measurement component 1145, a measurement calculation component 1150, a path loss measurement component 1155, a composite measurement component 1160, an adjusted measurement component 1165, a communication link component 1170, a cell priority component 1175, a quality metric component 1180, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The mobility procedure configuration component 1125 is capable of, configured to, or operable to support a means for receiving control signaling that identifies a set of candidate cells associated with a mobility procedure at the UE, where the control signaling indicates a quality metric associated with a first communication link between the UE and the set of candidate cells. The measurement component 1130 is capable of, configured to, or operable to support a means for obtaining, for one or more candidate cells of the set of candidate cells, a respective first measurement corresponding to the first communication link and a respective second measurement corresponding to a second communication link between the UE and the set of candidate cells. The mobility report component 1135 is capable of, configured to, or operable to support a means for transmitting a mobility report that indicates a subset of candidate cells of the set of candidate cells in accordance with the obtaining, where the respective first measurement of each candidate cell of the subset of candidate cells satisfies the quality metric.

In some examples, to support performing the mobility procedure, the candidate cell communication component 1140 is capable of, configured to, or operable to support a means for communicating, for the first communication link and the second communication link, with a first candidate cell identified from the subset of candidate cells in accordance with transmitting the mobility report.

In some examples, the control signaling further indicates a respective priority for measuring the second communication link for each candidate cell of the set of candidate cells, and the measurement component 1130 is capable of, configured to, or operable to support a means for obtaining the respective first measurement and the respective second measurement of the one or more candidate cells according to an order that is in accordance with the respective priority of each candidate cell of the set of candidate cells.

In some examples, to support obtaining, the reference signal measurement component 1145 is capable of, configured to, or operable to support a means for receiving, via the second communication link, a first reference signal from a first candidate cell of the set of candidate cells, where the first reference signal corresponds to a second reference signal associated with the first communication link. In some examples, to support obtaining, the measurement component 1130 is capable of, configured to, or operable to support a means for obtaining the respective second measurement of the first candidate cell in accordance with measuring the first reference signal. In some examples, to support obtaining, the measurement calculation component 1150 is capable of, configured to, or operable to support a means for deriving the respective first measurement associated with the first candidate cell in accordance with the respective second measurement, a transmission power of the UE, an offset, or any combination thereof.

In some examples, to support obtaining, the reference signal measurement component 1145 is capable of, configured to, or operable to support a means for receiving, via the second communication link, a path loss reference signal from a first candidate cell of the set of candidate cells. In some examples, to support obtaining, the path loss measurement component 1155 is capable of, configured to, or operable to support a means for obtaining a path loss of the second communication link in accordance with measuring the path loss reference signal. In some examples, to support obtaining, the measurement calculation component 1150 is capable of, configured to, or operable to support a means for deriving the respective first measurement associated with the first candidate cell in accordance with a transmission power of the UE and the path loss of the second communication link.

In some examples, the control signaling further indicates a rule for combining the respective first measurement with the respective second measurement, and the composite measurement component 1160 is capable of, configured to, or operable to support a means for obtaining, for each candidate cell, a respective composite measurement in accordance with a combination of the respective first measurement and the respective second measurement according to the rule, where an order of the subset of candidate cells in the mobility report is in accordance with the respective composite measurement of each candidate cell of the set of candidate cells.

In some examples, the control signaling further indicates a first scaling factor associated with the first communication link and a second scaling factor associated with the second communication link, and the adjusted measurement component 1165 is capable of, configured to, or operable to support a means for obtaining a respective adjusted first measurement in accordance with an application of the first scaling factor to each respective first measurement. In some examples, the control signaling further indicates a first scaling factor associated with the first communication link and a second scaling factor associated with the second communication link, and the adjusted measurement component 1165 is capable of, configured to, or operable to support a means for obtaining a respective adjusted second measurement in accordance with an application of the second scaling factor to each respective second measurement, where the respective adjusted first measurement of each candidate cell of the subset of candidate cells satisfies the quality metric, and where the respective adjusted second measurement of each candidate cell of the subset of candidate cells satisfies a second quality metric.

In some examples, the control signaling further indicates a second quality metric associated with the second communication link for each candidate cell of the set of candidate cells. In some examples, the respective second measurement of each candidate cell of the subset of candidate cells satisfies the second quality metric.

In some examples, the control signaling further indicates a threshold quantity of candidate cells to be reported. In some examples, a quantity of the subset of candidate cells satisfies the threshold quantity of candidate cells.

In some examples, the first communication link includes an uplink and the second communication link includes a downlink. In some examples, the first communication link includes the downlink and the second communication link includes the uplink.

Additionally, or alternatively, the communications manager 1120 may support wireless communications in accordance with examples as disclosed herein. In some examples, the mobility procedure configuration component 1125 is capable of, configured to, or operable to support a means for receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. In some examples, the measurement component 1130 is capable of, configured to, or operable to support a means for obtaining a respective first measurement associated with the first communication link for the first set of candidate cells in accordance with the respective first priorities. In some examples, the measurement component 1130 is capable of, configured to, or operable to support a means for obtaining a respective second measurement associated with the second communication link for the second set of candidate cells in accordance with the respective second priorities. In some examples, the mobility report component 1135 is capable of, configured to, or operable to support a means for transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

In some examples, to support performing the mobility procedure, the candidate cell communication component 1140 is capable of, configured to, or operable to support a means for communicating, for the first communication link, with a first candidate cell identified from the first subset of candidate cells in accordance with transmitting the mobility report. In some examples, to support performing the mobility procedure, the candidate cell communication component 1140 is capable of, configured to, or operable to support a means for communicating, for the second communication link, with a second candidate cell identified from the second subset of candidate cells in accordance with transmitting the mobility report.

In some examples, the control signaling includes a list indicating the first set of candidate cells, and the cell priority component 1175 is capable of, configured to, or operable to support a means for determining the respective first priorities for each candidate cell of the first set of candidate cells in accordance with an order of a respective index of each candidate cell of the first set of candidate cells within the list.

In some examples, the control signaling includes a list indicating the second set of candidate cells, and the cell priority component 1175 is capable of, configured to, or operable to support a means for determining the respective second priorities for each candidate cell of the second set of candidate cells in accordance with an order of a respective index of each candidate cell of the second set of candidate cells within the list.

In some examples, to support determining, the cell priority component 1175 is capable of, configured to, or operable to support a means for determining the respective first priorities for each candidate cell of the first set of candidate cells in accordance with the respective IDs.

In some examples, to support determining, the cell priority component 1175 is capable of, configured to, or operable to support a means for determining the respective second priorities for each candidate cell of the second set of candidate cells in accordance with the respective IDs.

In some examples, the control signaling indicates a first scaling factor associated with the first communication link and a second scaling factor associated with the second communication link, and the adjusted measurement component 1165 is capable of, configured to, or operable to support a means for obtaining a respective adjusted first measurement in accordance with an application of the first scaling factor to each respective first measurement. In some examples, the control signaling indicates a first scaling factor associated with the first communication link and a second scaling factor associated with the second communication link, and the adjusted measurement component 1165 is capable of, configured to, or operable to support a means for obtaining a respective adjusted second measurement in accordance with an application of the second scaling factor to each respective second measurement, where the respective adjusted first measurement of each candidate cell of the first subset of candidate cells satisfies a first quality metric, and where the respective adjusted second measurement of each candidate cell of the second subset of candidate cells satisfies a second quality metric.

In some examples, the control signaling includes a flag that indicates whether the UE is to implicitly determine the respective first priorities and implicitly determine the respective second priorities.

In some examples, the first set of candidate cells and the second set of candidate cells are equivalent. In some examples, the control signaling includes a flag that indicates the respective first priorities and the respective second priorities are equivalent.

In some examples, the control signaling further indicates a first quality metric associated with the first communication link and a second quality metric associated with the second communication link. In some examples, the respective first measurement for each candidate cell of the first subset of candidate cells satisfies the first quality metric. In some examples, the respective second measurement for each candidate cell of the second subset of candidate cells satisfies the second quality metric.

Additionally, or alternatively, the communications manager 1120 may support wireless communications in accordance with examples as disclosed herein. In some examples, the mobility procedure configuration component 1125 is capable of, configured to, or operable to support a means for receiving control signaling that indicates a set of candidate cells associated with a mobility procedure at the UE, where the control signaling identifies a respective set of parameters associated with measurements of a first communication link for each candidate cell of the set of candidate cells. In some examples, the measurement component 1130 is capable of, configured to, or operable to support a means for obtaining respective first measurements associated with the first communication link for each candidate cell of the set of candidate cells according to the respective sets of parameters. In some examples, the measurement component 1130 is capable of, configured to, or operable to support a means for obtaining respective second measurements associated with a second communication link for each candidate cell of the set of candidate cells in accordance with the control signaling. In some examples, the mobility report component 1135 is capable of, configured to, or operable to support a means for transmitting a mobility report that indicates a subset of candidate cells of the set of candidate cells and indicates at least the respective first measurements associated with one or more candidate cells of the subset of candidate cells.

In some examples, to support obtaining, the reference signal measurement component 1145 is capable of, configured to, or operable to support a means for receiving, via the second communication link, a first reference signal from a first candidate cell of the set of candidate cells, where the first reference signal corresponds to a second reference signal associated with the first communication link. In some examples, to support obtaining, the reference signal measurement component 1145 is capable of, configured to, or operable to support a means for obtaining the respective second measurements of the first candidate cell in accordance with measuring the first reference signal. In some examples, to support obtaining, the measurement calculation component 1150 is capable of, configured to, or operable to support a means for deriving the respective first measurements associated with the first candidate cell in accordance with the respective second measurements, a transmission power of the UE, an offset, or any combination thereof, where the respective set of parameters associated with the first candidate cell includes the offset.

In some examples, to support obtaining, the reference signal measurement component 1145 is capable of, configured to, or operable to support a means for receiving, via the second communication link, a path loss reference signal from a first candidate cell of the set of candidate cells. In some examples, to support obtaining, the path loss measurement component 1155 is capable of, configured to, or operable to support a means for obtaining a path loss of the second communication link in accordance with measuring the path loss reference signal. In some examples, to support obtaining, the measurement calculation component 1150 is capable of, configured to, or operable to support a means for deriving the respective first measurements associated with the first candidate cell in accordance with a transmission power of the UE and the path loss of the second communication link.

In some examples, to support transmitting the mobility report, the mobility report component 1135 is capable of, configured to, or operable to support a means for transmitting, via the mobility report, an indication of a respective set of beams per candidate cell of the subset of candidate cells and an indication of a respective first measurement for each beam of the respective set of beams per candidate cell, where a quantity of the subset of candidate cells satisfies the threshold quantity of candidate cells, and where a quantity of beams of the respective set of beams per candidate cell satisfies the threshold quantity of beams.

In some examples, to support transmitting the mobility report, the mobility report component 1135 is capable of, configured to, or operable to support a means for transmitting, via the mobility report, an indication of a respective set of beams per candidate cell of a first subset of candidate cells and an indication of a respective first measurement for each beam of the respective set of beams per candidate cell of the first subset of candidate cells, where a quantity of the first subset of candidate cells satisfies the first threshold quantity of candidate cells. In some examples, to support transmitting the mobility report, the mobility report component 1135 is capable of, configured to, or operable to support a means for transmitting, via the mobility report, an indication of a respective set of beams per candidate cell of a second subset of candidate cells and an indication of a respective second measurement for each beam of the respective set of beams per candidate cell of the second subset of candidate cells, where a quantity of the second subset of candidate cells satisfies the second threshold quantity of candidate cells.

In some examples, to support transmitting the mobility report, the mobility report component 1135 is capable of, configured to, or operable to support a means for transmitting, via the mobility report, an indication of a respective set of beams per candidate cell of the subset of candidate cells, an indication of a respective first measurement for each beam of the respective set of beams per candidate cell of the subset of candidate cells, and an indication of a respective second measurement for each beam of the respective set of beams per candidate cell of the subset of candidate cells, where a quantity of the subset of candidate cells satisfies the threshold quantity of candidate cells.

In some examples, to support transmitting the mobility report, the mobility report component 1135 is capable of, configured to, or operable to support a means for transmitting, via the mobility report, an indication of a respective set of beams per candidate cell of the subset of candidate cells, an indication of a respective first measurement for each beam of a first subset of beams of each respective set of beams, and an indication of a respective second measurement for each beam of a second subset of beams of each respective set of beams, where a quantity of the subset of candidate cells satisfies the threshold quantity of candidate cells.

In some examples, to support transmitting the mobility report, the mobility report component 1135 is capable of, configured to, or operable to support a means for transmitting, via the mobility report and for a first candidate cell, a first set of beams and a respective first measurement for each beam of the first set of beams in accordance with the control signaling. In some examples, to support transmitting the mobility report, the mobility report component 1135 is capable of, configured to, or operable to support a means for transmitting, via the mobility report and for a second candidate cell, a second set of beams and a respective second measurement for each beam of the second set of beams in accordance with the control signaling.

In some examples, the respective set of parameters for each candidate cell of the set of candidate cells includes a respective bandwidth, a respective transmission power, a respective pathloss, respective traffic load information, respective traffic utilization, respective quantity of active communication links, or any combination thereof.

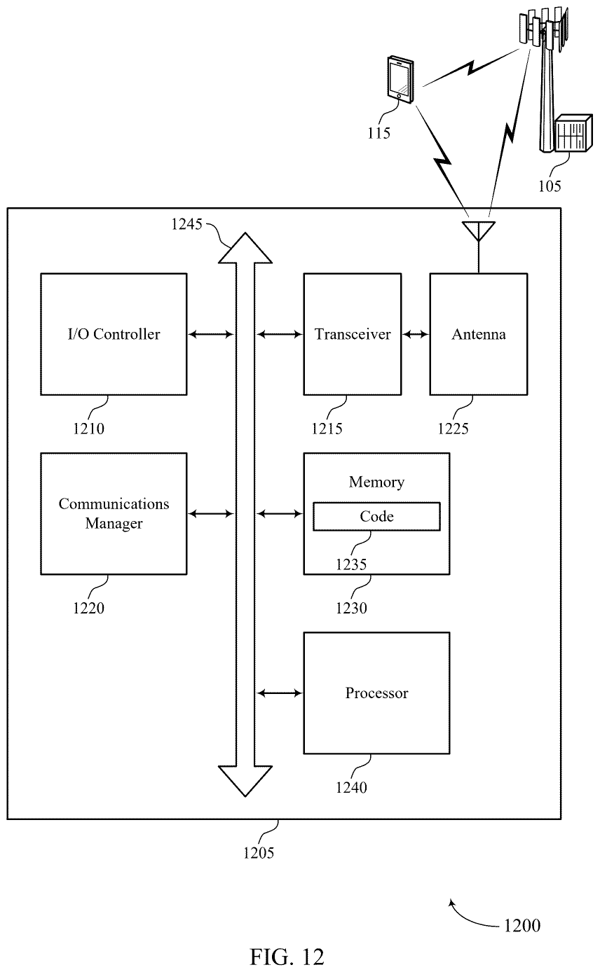

FIG. 12 shows a diagram of a system 1200 including a device 1205 that supports cell selection in wireless communications systems in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting cell selection in wireless communications systems). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving control signaling that identifies a set of candidate cells associated with a mobility procedure at the UE, where the control signaling indicates a quality metric associated with a first communication link between the UE and the set of candidate cells. The communications manager 1220 is capable of, configured to, or operable to support a means for obtaining, for one or more candidate cells of the set of candidate cells, a respective first measurement corresponding to the first communication link and a respective second measurement corresponding to a second communication link between the UE and the set of candidate cells. The communications manager 1220 is capable of, configured to, or operable to support a means for transmitting a mobility report that indicates a subset of candidate cells of the set of candidate cells in accordance with the obtaining, where the respective first measurement of each candidate cell of the subset of candidate cells satisfies the quality metric.

Additionally, or alternatively, the communications manager 1220 may support wireless communications in accordance with examples as disclosed herein. For example, the communications manager 1220 is capable of, configured to, or operable to support a means for receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. The communications manager 1220 is capable of, configured to, or operable to support a means for obtaining a respective first measurement associated with the first communication link for the first set of candidate cells in accordance with the respective first priorities. The communications manager 1220 is capable of, configured to, or operable to support a means for obtaining a respective second measurement associated with the second communication link for the second set of candidate cells in accordance with the respective second priorities. The communications manager 1220 is capable of, configured to, or operable to support a means for transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements.

Additionally, or alternatively, the communications manager 1220 may support wireless communications in accordance with examples as disclosed herein. For example, the communications manager 1220 is capable of, configured to, or operable to support a means for receiving control signaling that indicates a set of candidate cells associated with a mobility procedure at the UE, where the control signaling identifies a respective set of parameters associated with measurements of a first communication link for each candidate cell of the set of candidate cells. The communications manager 1220 is capable of, configured to, or operable to support a means for obtaining respective first measurements associated with the first communication link for each candidate cell of the set of candidate cells according to the respective sets of parameters. The communications manager 1220 is capable of, configured to, or operable to support a means for obtaining respective second measurements associated with a second communication link for each candidate cell of the set of candidate cells in accordance with the control signaling. The communications manager 1220 is capable of, configured to, or operable to support a means for transmitting a mobility report that indicates a subset of candidate cells of the set of candidate cells and indicates at least the respective first measurements associated with one or more candidate cells of the subset of candidate cells.

By including or configuring the communications manager 1220 in accordance with examples as described herein, the device 1205 may support techniques for improved communication reliability, reduced latency, more efficient utilization of communication resources, improved utilization of processing capability, among other examples.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of cell selection in wireless communications systems as described herein, or the at least one processor 1240 and the at least one memory 1230 may be otherwise configured to, individually or collectively, perform or support such operations.

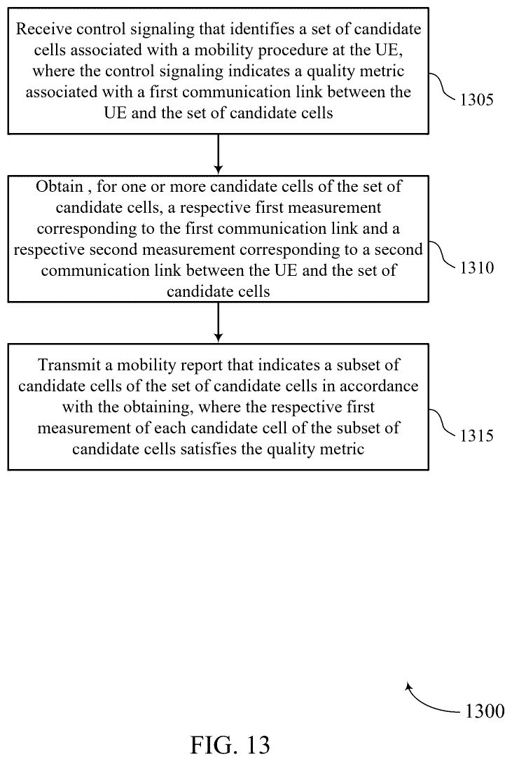

FIG. 13 shows a flowchart illustrating a method 1300 that supports cell selection in wireless communications systems in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that identifies a set of candidate cells associated with a mobility procedure at the UE, where the control signaling indicates a quality metric associated with a first communication link between the UE and the set of candidate cells. The operations of 1305 may be performed in accordance with examples as disclosed herein. In some examples, aspects of the operations of 1305 may be performed by a mobility procedure configuration component 1125 as described with reference to FIG. 11.

At 1310, the method may include obtaining, for one or more candidate cells of the set of candidate cells, a respective first measurement corresponding to the first communication link and a respective second measurement corresponding to a second communication link between the UE and the set of candidate cells. The operations of 1310 may be performed in accordance with examples as disclosed herein. In some examples, aspects of the operations of 1310 may be performed by a measurement component 1130 as described with reference to FIG. 11.

At 1315, the method may include transmitting a mobility report that indicates a subset of candidate cells of the set of candidate cells in accordance with the obtaining, where the respective first measurement of each candidate cell of the subset of candidate cells satisfies the quality metric. The operations of 1315 may be performed in accordance with examples as disclosed herein. In some examples, aspects of the operations of 1315 may be performed by a mobility report component 1135 as described with reference to FIG. 11.

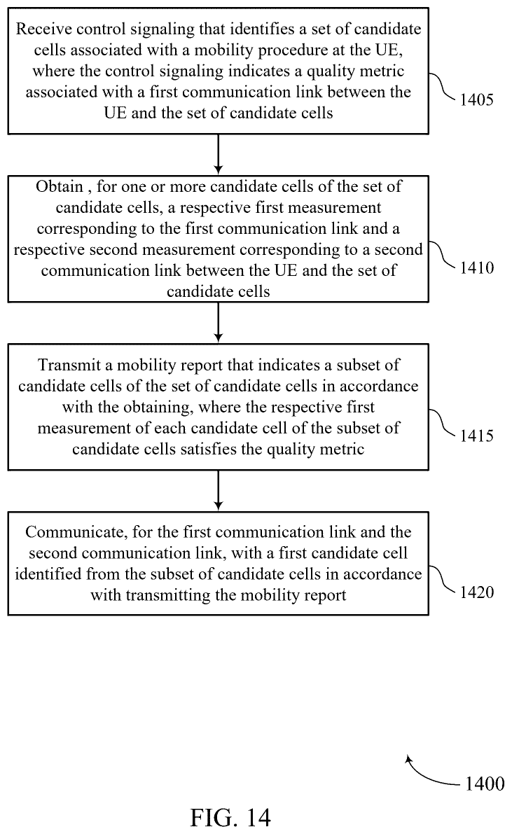

FIG. 14 shows a flowchart illustrating a method 1400 that supports cell selection in wireless communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that identifies a set of candidate cells associated with a mobility procedure at the UE, where the control signaling indicates a quality metric associated with a first communication link between the UE and the set of candidate cells. The operations of 1405 may be performed in accordance with examples as disclosed herein. In some examples, aspects of the operations of 1405 may be performed by a mobility procedure configuration component 1125 as described with reference to FIG. 11.

At 1410, the method may include obtaining, for one or more candidate cells of the set of candidate cells, a respective first measurement corresponding to the first communication link and a respective second measurement corresponding to a second communication link between the UE and the set of candidate cells. The operations of 1410 may be performed in accordance with examples as disclosed herein. In some examples, aspects of the operations of 1410 may be performed by a measurement component 1130 as described with reference to FIG. 11.

At 1415, the method may include transmitting a mobility report that indicates a subset of candidate cells of the set of candidate cells in accordance with the obtaining, where the respective first measurement of each candidate cell of the subset of candidate cells satisfies the quality metric. The operations of 1415 may be performed in accordance with examples as disclosed herein. In some examples, aspects of the operations of 1415 may be performed by a mobility report component 1135 as described with reference to FIG. 11.

At 1420, the method may include communicating, for the first communication link and the second communication link, with a first candidate cell identified from the subset of candidate cells in accordance with transmitting the mobility report. The operations of 1420 may be performed in accordance with examples as disclosed herein. In some examples, aspects of the operations of 1420 may be performed by a candidate cell communication component 1140 as described with reference to FIG. 11.

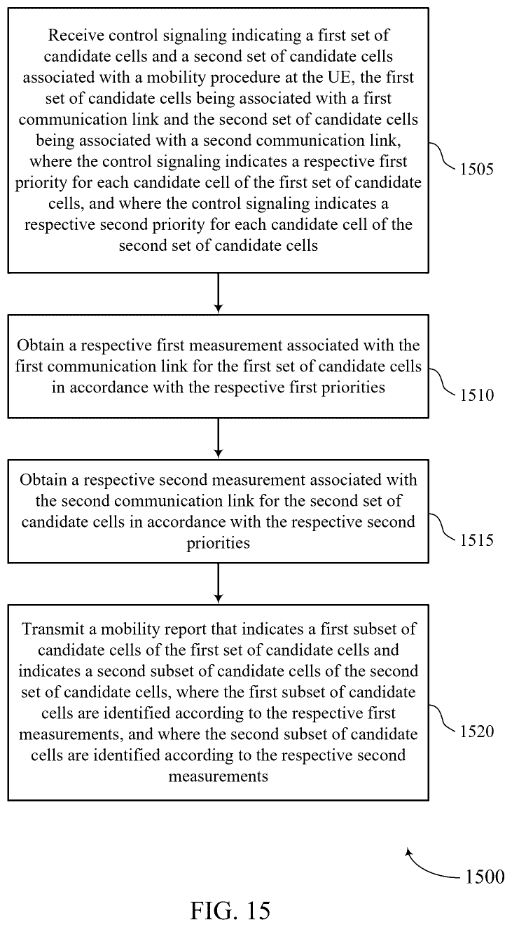

FIG. 15 shows a flowchart illustrating a method 1500 that supports cell selection in wireless communications systems in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. The operations of 1505 may be performed in accordance with examples as disclosed herein. In some examples, aspects of the operations of 1505 may be performed by a mobility procedure configuration component 1125 as described with reference to FIG. 11.

At 1510, the method may include obtaining a respective first measurement associated with the first communication link for the first set of candidate cells in accordance with the respective first priorities. The operations of 1510 may be performed in accordance with examples as disclosed herein. In some examples, aspects of the operations of 1510 may be performed by a measurement component 1130 as described with reference to FIG. 11.

At 1515, the method may include obtaining a respective second measurement associated with the second communication link for the second set of candidate cells in accordance with the respective second priorities. The operations of 1515 may be performed in accordance with examples as disclosed herein. In some examples, aspects of the operations of 1515 may be performed by a measurement component 1130 as described with reference to FIG. 11.

At 1520, the method may include transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements. The operations of 1520 may be performed in accordance with examples as disclosed herein. In some examples, aspects of the operations of 1520 may be performed by a mobility report component 1135 as described with reference to FIG. 11.

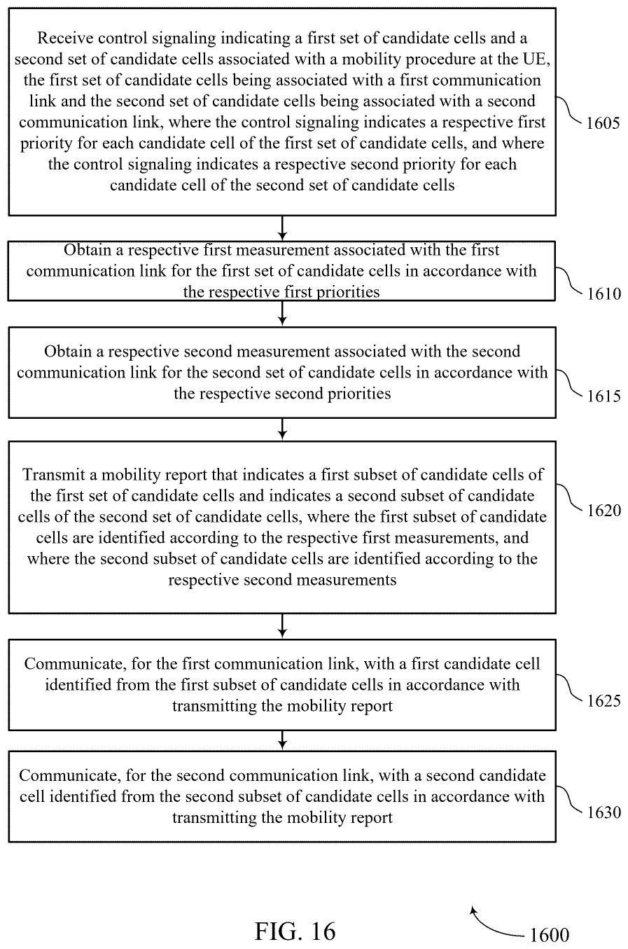

FIG. 16 shows a flowchart illustrating a method 1600 that supports cell selection in wireless communications systems in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating a first set of candidate cells and a second set of candidate cells associated with a mobility procedure at the UE, the first set of candidate cells being associated with a first communication link and the second set of candidate cells being associated with a second communication link, where the control signaling indicates a respective first priority for each candidate cell of the first set of candidate cells, and where the control signaling indicates a respective second priority for each candidate cell of the second set of candidate cells. The operations of 1605 may be performed in accordance with examples as disclosed herein. In some examples, aspects of the operations of 1605 may be performed by a mobility procedure configuration component 1125 as described with reference to FIG. 11.

At 1610, the method may include obtaining a respective first measurement associated with the first communication link for the first set of candidate cells in accordance with the respective first priorities. The operations of 1610 may be performed in accordance with examples as disclosed herein. In some examples, aspects of the operations of 1610 may be performed by a measurement component 1130 as described with reference to FIG. 11.

At 1615, the method may include obtaining a respective second measurement associated with the second communication link for the second set of candidate cells in accordance with the respective second priorities. The operations of 1615 may be performed in accordance with examples as disclosed herein. In some examples, aspects of the operations of 1615 may be performed by a measurement component 1130 as described with reference to FIG. 11.

At 1620, the method may include transmitting a mobility report that indicates a first subset of candidate cells of the first set of candidate cells and indicates a second subset of candidate cells of the second set of candidate cells, where the first subset of candidate cells are identified according to the respective first measurements, and where the second subset of candidate cells are identified according to the respective second measurements. The operations of 1620 may be performed in accordance with examples as disclosed herein. In some examples, aspects of the operations of 1620 may be performed by a mobility report component 1135 as described with reference to FIG. 11.

At 1625, the method may include communicating, for the first communication link, with a first candidate cell identified from the first subset of candidate cells in accordance with transmitting the mobility report. The operations of 1625 may be performed in accordance with examples as disclosed herein. In some examples, aspects of the operations of 1625 may be performed by a candidate cell communication component 1140 as described with reference to FIG. 11.

At 1630, the method may include communicating, for the second communication link, with a second candidate cell identified from the second subset of candidate cells in accordance with transmitting the mobility report. The operations of 1630 may be performed in accordance with examples as disclosed herein. In some examples, aspects of the operations of 1630 may be performed by a candidate cell communication component 1140 as described with reference to FIG. 11.

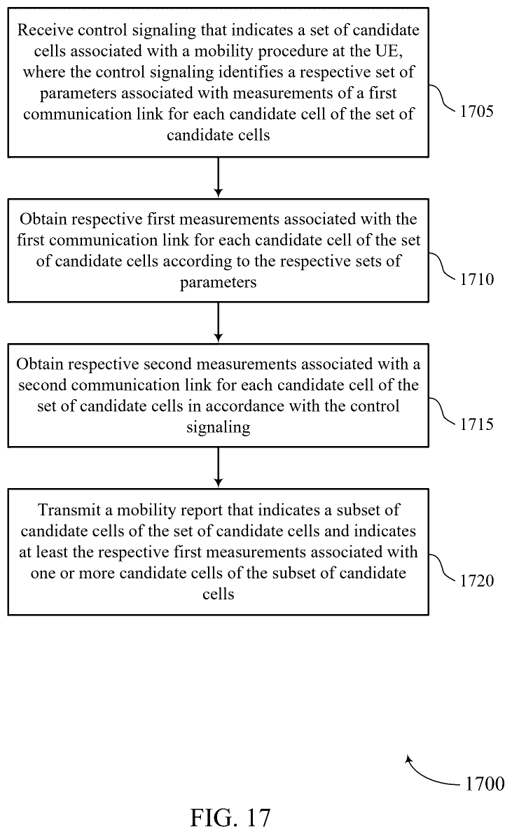

FIG. 17 shows a flowchart illustrating a method 1700 that supports cell selection in wireless communications systems in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving control signaling that indicates a set of candidate cells associated with a mobility procedure at the UE, where the control signaling identifies a respective set of parameters associated with measurements of a first communication link for each candidate cell of the set of candidate cells. The operations of 1705 may be performed in accordance with examples as disclosed herein. In some examples, aspects of the operations of 1705 may be performed by a mobility procedure configuration component 1125 as described with reference to FIG. 11.

At 1710, the method may include obtaining respective first measurements associated with the first communication link for each candidate cell of the set of candidate cells according to the respective sets of parameters. The operations of 1710 may be performed in accordance with examples as disclosed herein. In some examples, aspects of the operations of 1710 may be performed by a measurement component 1130 as described with reference to FIG. 11.

At 1715, the method may include obtaining respective second measurements associated with a second communication link for each candidate cell of the set of candidate cells in accordance with the control signaling. The operations of 1715 may be performed in accordance with examples as disclosed herein. In some examples, aspects of the operations of 1715 may be performed by a measurement component 1130 as described with reference to FIG. 11.

At 1720, the method may include transmitting a mobility report that indicates a subset of candidate cells of the set of candidate cells and indicates at least the respective first measurements associated with one or more candidate cells of the subset of candidate cells. The operations of 1720 may be performed in accordance with examples as disclosed herein. In some examples, aspects of the operations of 1720 may be performed by a mobility report component 1135 as described with reference to FIG. 11.

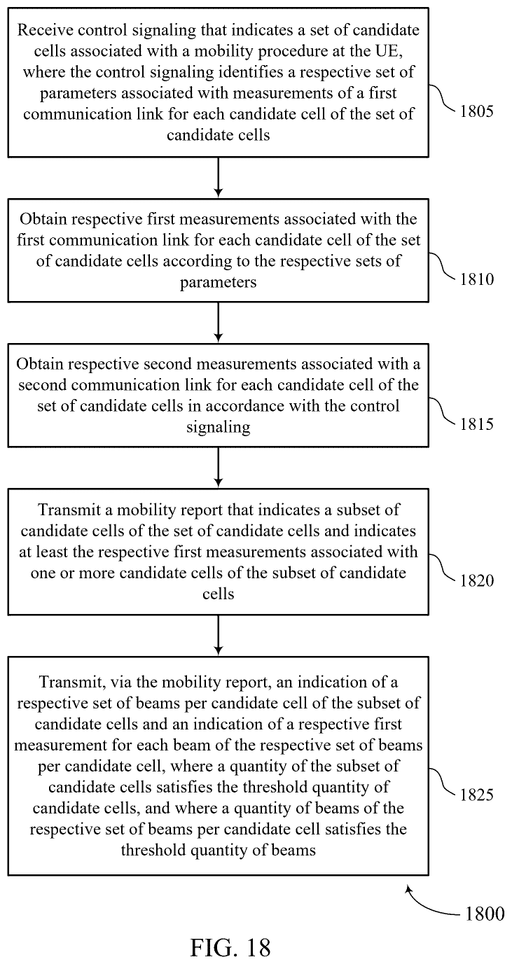

FIG. 18 shows a flowchart illustrating a method 1800 that supports cell selection in wireless communications systems in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving control signaling that indicates a set of candidate cells associated with a mobility procedure at the UE, where the control signaling identifies a respective set of parameters associated with measurements of a first communication link for each candidate cell of the set of candidate cells. The operations of 1805 may be performed in accordance with examples as disclosed herein. In some examples, aspects of the operations of 1805 may be performed by a mobility procedure configuration component 1125 as described with reference to FIG. 11.

At 1810, the method may include obtaining respective first measurements associated with the first communication link for each candidate cell of the set of candidate cells according to the respective sets of parameters. The operations of 1810 may be performed in accordance with examples as disclosed herein. In some examples, aspects of the operations of 1810 may be performed by a measurement component 1130 as described with reference to FIG. 11.

At 1815, the method may include obtaining respective second measurements associated with a second communication link for each candidate cell of the set of candidate cells in accordance with the control signaling. The operations of 1815 may be performed in accordance with examples as disclosed herein. In some examples, aspects of the operations of 1815 may be performed by a measurement component 1130 as described with reference to FIG. 11.

At 1820, the method may include transmitting a mobility report that indicates a subset of candidate cells of the set of candidate cells and indicates at least the respective first measurements associated with one or more candidate cells of the subset of candidate cells. The operations of 1820 may be performed in accordance with examples as disclosed herein. In some examples, aspects of the operations of 1820 may be performed by a mobility report component 1135 as described with reference to FIG. 11.

At 1825, the method may include transmitting, via the mobility report, an indication of a respective set of beams per candidate cell of the subset of candidate cells and an indication of a respective first measurement for each beam of the respective set of beams per candidate cell, where a quantity of the subset of candidate cells satisfies the threshold quantity of candidate cells, and where a quantity of beams of the respective set of beams per candidate cell satisfies the threshold quantity of beams. The operations of 1825 may be performed in accordance with examples as disclosed herein. In some examples, aspects of the operations of 1825 may be performed by a mobility report component 1135 as described with reference to FIG. 11.

The following provides an overview of aspects of the present disclosure:

Aspect 1: A method for wireless communications by a UE, comprising: receiving control signaling that identifies a set of candidate cells associated with a mobility procedure at the UE, wherein the control signaling indicates a quality metric associated with a first communication link between the UE and the set of candidate cells; obtaining, for one or more candidate cells of the set of candidate cells, a respective first measurement corresponding to the first communication link and a respective second measurement corresponding to a second communication link between the UE and the set of candidate cells; and transmitting a mobility report that indicates a subset of candidate cells of the set of candidate cells in accordance with the obtaining, wherein the respective first measurement of each candidate cell of the subset of candidate cells satisfies the quality metric.

Aspect 2: The method of aspect 1, wherein performing the mobility procedure comprises: communicating, for the first communication link and the second communication link, with a first candidate cell identified from the subset of candidate cells in accordance with transmitting the mobility report.

Aspect 3: The method of any of aspects 1 through 2, wherein the control signaling further indicates a respective priority for measuring the second communication link for each candidate cell of the set of candidate cells, the method further comprising: obtaining the respective first measurement and the respective second measurement of the one or more candidate cells according to an order that is in accordance with the respective priority of each candidate cell of the set of candidate cells.

Aspect 4: The method of any of aspects 1 through 3, wherein the obtaining comprises: receiving, via the second communication link, a first reference signal from a first candidate cell of the set of candidate cells, wherein the first reference signal corresponds to a second reference signal associated with the first communication link; obtaining the respective second measurement of the first candidate cell in accordance with measuring the first reference signal; and deriving the respective first measurement associated with the first candidate cell in accordance with the respective second measurement, a transmission power of the UE, an offset, or any combination thereof.

Aspect 5: The method of any of aspects 1 through 4, wherein the obtaining comprises: receiving, via the second communication link, a path loss reference signal from a first candidate cell of the set of candidate cells; obtaining a path loss of the second communication link in accordance with measuring the path loss reference signal; and deriving the respective first measurement associated with the first candidate cell in accordance with a transmission power of the UE and the path loss of the second communication link.

Aspect 6: The method of any of aspects 1 through 5, wherein the control signaling further indicates a rule for combining the respective first measurement with the respective second measurement, the method further comprising: obtaining, for each candidate cell, a respective composite measurement in accordance with a combination of the respective first measurement and the respective second measurement according to the rule, wherein an order of the subset of candidate cells in the mobility report is in accordance with the respective composite measurement of each candidate cell of the set of candidate cells.

Aspect 7: The method of any of aspects 1 through 6, wherein the control signaling further indicates a first scaling factor associated with the first communication link and a second scaling factor associated with the second communication link, the method further comprising: obtaining a respective adjusted first measurement in accordance with an application of the first scaling factor to each respective first measurement; and obtaining a respective adjusted second measurement in accordance with an application of the second scaling factor to each respective second measurement, wherein the respective adjusted first measurement of each candidate cell of the subset of candidate cells satisfies the quality metric, and wherein the respective adjusted second measurement of each candidate cell of the subset of candidate cells satisfies a second quality metric.

Aspect 8: The method of any of aspects 1 through 7, wherein the control signaling further indicates a second quality metric associated with the second communication link for each candidate cell of the set of candidate cells, and the respective second measurement of each candidate cell of the subset of candidate cells satisfies the second quality metric.

Aspect 9: The method of any of aspects 1 through 8, wherein the control signaling further indicates a threshold quantity of candidate cells to be reported, and a quantity of the subset of candidate cells satisfies the threshold quantity of candidate cells.

Aspect 10: The method of any of aspects 1 through 9, wherein the first communication link comprises an uplink and the second communication link comprises a downlink; or the first communication link comprises the downlink and the second communication link comprises the uplink.

Aspect 11: A method for wireless communications by a UE, comprising: receiving control signaling indicating a first set of candidate cells and a second set of candidate cells associated with a mobility procedure at the UE, the first set of candidate cells being associated with a first communication link and the second set of candidate cells being associated with a second communication link, wherein the control signaling indicates a respective first priority for each candidate cell of the first set of candidate cells, and wherein the control signaling indicates a respective second priority for each candidate cell of the second set of candidate cells; obtaining a respective first measurement associated with the first communication link for the first set of candidate cells in accordance with the respective first priorities; obtaining a respective second measurement associated with the second communication link for the second set of candidate cells in accordance with the respective second priorities; and transmitting a mobility report that indicates a first subset of candidate cells of the first set of candidate cells and indicates a second subset of candidate cells of the second set of candidate cells, wherein the first subset of candidate cells are identified according to the respective first measurements, and wherein the second subset of candidate cells are identified according to the respective second measurements.

Aspect 12: The method of aspect 11, wherein performing the mobility procedure comprises: communicating, for the first communication link, with a first candidate cell identified from the first subset of candidate cells in accordance with transmitting the mobility report; and communicating, for the second communication link, with a second candidate cell identified from the second subset of candidate cells in accordance with transmitting the mobility report.

Aspect 13: The method of any of aspects 11 through 12, wherein the control signaling comprises a list indicating the first set of candidate cells, and wherein the method further comprises: determining the respective first priorities for each candidate cell of the first set of candidate cells in accordance with an order of a respective index of each candidate cell of the first set of candidate cells within the list.

Aspect 14: The method of any of aspects 11 through 13, wherein the control signaling comprises a list indicating the second set of candidate cells, and wherein the method further comprises: determining the respective second priorities for each candidate cell of the second set of candidate cells in accordance with an order of a respective index of each candidate cell of the second set of candidate cells within the list.

Aspect 15: The method of any of aspects 11 through 14, wherein the control signaling comprises a respective identifier associated with each candidate cell of the first set of candidate cells: determining the respective first priorities for each candidate cell of the first set of candidate cells in accordance with the respective identifiers.

Aspect 16: The method of any of aspects 11 through 15, wherein the control signaling comprises a respective identifier associated with each candidate cell of the second set of candidate cells: determining the respective second priorities for each candidate cell of the second set of candidate cells in accordance with the respective identifiers.

Aspect 17: The method of any of aspects 11 through 16, wherein the control signaling indicates a first scaling factor associated with the first communication link and a second scaling factor associated with the second communication link, the method further comprising: obtaining a respective adjusted first measurement in accordance with an application of the first scaling factor to each respective first measurement; and obtaining a respective adjusted second measurement in accordance with an application of the second scaling factor to each respective second measurement, wherein the respective adjusted first measurement of each candidate cell of the first subset of candidate cells satisfies a first quality metric, and wherein the respective adjusted second measurement of each candidate cell of the second subset of candidate cells satisfies a second quality metric.

Aspect 18: The method of any of aspects 11 through 17, wherein the control signaling comprises a flag that indicates whether the UE is to implicitly determine the respective first priorities and implicitly determine the respective second priorities.

Aspect 19: The method of any of aspects 11 through 18, wherein the first set of candidate cells and the second set of candidate cells are equivalent, and the control signaling comprises a flag that indicates the respective first priorities and the respective second priorities are equivalent.

Aspect 20: The method of any of aspects 11 through 19, wherein the control signaling further indicates a first quality metric associated with the first communication link and a second quality metric associated with the second communication link, the respective first measurement for each candidate cell of the first subset of candidate cells satisfies the first quality metric, and the respective second measurement for each candidate cell of the second subset of candidate cells satisfies the second quality metric.

Aspect 21: A method for wireless communications by a UE, comprising: receiving control signaling that indicates a set of candidate cells associated with a mobility procedure at the UE, wherein the control signaling identifies a respective set of parameters associated with measurements of a first communication link for each candidate cell of the set of candidate cells; obtaining respective first measurements associated with the first communication link for each candidate cell of the set of candidate cells according to the respective sets of parameters; obtaining respective second measurements associated with a second communication link for each candidate cell of the set of candidate cells in accordance with the control signaling; and transmitting a mobility report that indicates a subset of candidate cells of the set of candidate cells and indicates at least the respective first measurements associated with one or more candidate cells of the subset of candidate cells.

Aspect 22: The method of aspect 21, wherein the obtaining comprises: receiving, via the second communication link, a first reference signal from a first candidate cell of the set of candidate cells, wherein the first reference signal corresponds to a second reference signal associated with the first communication link; obtaining the respective second measurements of the first candidate cell in accordance with measuring the first reference signal; and deriving the respective first measurements associated with the first candidate cell in accordance with the respective second measurements, a transmission power of the UE, an offset, or any combination thereof, wherein the respective set of parameters associated with the first candidate cell comprises the offset.

Aspect 23: The method of any of aspects 21 through 22, wherein the obtaining comprises: receiving, via the second communication link, a path loss reference signal from a first candidate cell of the set of candidate cells; obtaining a path loss of the second communication link in accordance with measuring the path loss reference signal; and deriving the respective first measurements associated with the first candidate cell in accordance with a transmission power of the UE and the path loss of the second communication link.

Aspect 24: The method of any of aspects 21 through 23, wherein the control signaling further indicates a threshold quantity of candidate cells to be reported and a threshold quantity of beams per candidate cell to be reported, wherein transmitting the mobility report comprises: transmitting, via the mobility report, an indication of a respective set of beams per candidate cell of the subset of candidate cells and an indication of a respective first measurement for each beam of the respective set of beams per candidate cell, wherein a quantity of the subset of candidate cells satisfies the threshold quantity of candidate cells, and wherein a quantity of beams of the respective set of beams per candidate cell satisfies the threshold quantity of beams.

Aspect 25: The method of any of aspects 21 through 24, wherein the control signaling further indicates a first threshold quantity of candidate cells to be reported for the first communication link and a second threshold quantity of candidate cells to be reported for the second communication link, wherein transmitting the mobility report comprises: transmitting, via the mobility report, an indication of a respective set of beams per candidate cell of a first subset of candidate cells and an indication of a respective first measurement for each beam of the respective set of beams per candidate cell of the first subset of candidate cells, wherein a quantity of the first subset of candidate cells satisfies the first threshold quantity of candidate cells; and transmitting, via the mobility report, an indication of a respective set of beams per candidate cell of a second subset of candidate cells and an indication of a respective second measurement for each beam of the respective set of beams per candidate cell of the second subset of candidate cells, wherein a quantity of the second subset of candidate cells satisfies the second threshold quantity of candidate cells.

Aspect 26: The method of any of aspects 21 through 25, wherein the control signaling further indicates a threshold quantity of candidate cells to be reported for both the first communication link and the second communication link, wherein transmitting the mobility report comprises: transmitting, via the mobility report, an indication of a respective set of beams per candidate cell of the subset of candidate cells, an indication of a respective first measurement for each beam of the respective set of beams per candidate cell of the subset of candidate cells, and an indication of a respective second measurement for each beam of the respective set of beams per candidate cell of the subset of candidate cells, wherein a quantity of the subset of candidate cells satisfies the threshold quantity of candidate cells.

Aspect 27: The method of any of aspects 21 through 26, wherein the control signaling further indicates a threshold quantity of candidate cells to be reported, wherein transmitting the mobility report comprises: transmitting, via the mobility report, an indication of a respective set of beams per candidate cell of the subset of candidate cells, an indication of a respective first measurement for each beam of a first subset of beams of each respective set of beams, and an indication of a respective second measurement for each beam of a second subset of beams of each respective set of beams, wherein a quantity of the subset of candidate cells satisfies the threshold quantity of candidate cells.

Aspect 28: The method of any of aspects 21 through 27, wherein the control signaling further indicates a threshold quantity of candidate cells to be reported, an indication, per candidate cell, of a threshold quantity of beams to be reported, an indication, per candidate cell, of whether the respective first measurements are to be reported or the respective second measurements are to be reported, wherein transmitting the mobility report comprises: transmitting, via the mobility report and for a first candidate cell, a first set of beams and a respective first measurement for each beam of the first set of beams in accordance with the control signaling; and transmitting, via the mobility report and for a second candidate cell, a second set of beams and a respective second measurement for each beam of the second set of beams in accordance with the control signaling.

Aspect 29: The method of any of aspects 21 through 28, wherein the respective set of parameters for each candidate cell of the set of candidate cells comprises a respective bandwidth, a respective transmission power, a respective pathloss, respective traffic load information, respective traffic utilization, respective quantity of active communication links, or any combination thereof.

Aspect 30: A UE for wireless communications, comprising one or more memories storing processor-executable code, and one or more processors coupled with the one or more memories and individually or collectively operable to execute the code to cause the UE to perform a method of any of aspects 1 through 10.

Aspect 31: A UE for wireless communications, comprising at least one means for performing a method of any of aspects 1 through 10.

Aspect 32: A non-transitory computer-readable medium storing code for wireless communications, the code comprising instructions executable by one or more processors to perform a method of any of aspects 1 through 10.

Aspect 33: A UE for wireless communications, comprising one or more memories storing processor-executable code, and one or more processors coupled with the one or more memories and individually or collectively operable to execute the code to cause the UE to perform a method of any of aspects 11 through 20.

Aspect 34: A UE for wireless communications, comprising at least one means for performing a method of any of aspects 11 through 20.

Aspect 35: A non-transitory computer-readable medium storing code for wireless communications, the code comprising instructions executable by one or more processors to perform a method of any of aspects 11 through 20.

Aspect 36: A UE for wireless communications, comprising one or more memories storing processor-executable code, and one or more processors coupled with the one or more memories and individually or collectively operable to execute the code to cause the UE to perform a method of any of aspects 21 through 29.

Aspect 37: A UE for wireless communications, comprising at least one means for performing a method of any of aspects 21 through 29.

Aspect 38: A non-transitory computer-readable medium storing code for wireless communications, the code comprising instructions executable by one or more processors to perform a method of any of aspects 21 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that identifies a set of candidate cells associated with a mobility procedure at the UE, wherein the control signaling indicates a quality metric associated with a first communication link between the UE and the set of candidate cells;
obtain, for one or more candidate cells of the set of candidate cells, a respective first measurement corresponding to the first communication link and a respective second measurement corresponding to a second communication link between the UE and the set of candidate cells; and
transmit a mobility report that indicates a subset of candidate cells of the set of candidate cells in accordance with the obtaining, wherein the respective first measurement of each candidate cell of the subset of candidate cells satisfies the quality metric.

2. The UE of claim 1, wherein, to perform the mobility procedure, the one or more processors are individually or collectively operable to execute the code to cause the UE to:
communicate, for the first communication link and the second communication link, with a first candidate cell identified from the subset of candidate cells in accordance with transmitting the mobility report.

3. The UE of claim 1, wherein the control signaling further indicates a respective priority for measuring the second communication link for each candidate cell of the set of candidate cells, and the one or more processors are individually or collectively further operable to execute the code to cause the UE to:
obtain the respective first measurement and the respective second measurement of the one or more candidate cells according to an order that is in accordance with the respective priority of each candidate cell of the set of candidate cells.

4. The UE of claim 1, wherein, to obtain the respective first measurement and the respective second measurement, the one or more processors are individually or collectively operable to execute the code to cause the UE to:
receive, via the second communication link, a first reference signal from a first candidate cell of the set of candidate cells, wherein the first reference signal corresponds to a second reference signal associated with the first communication link;
obtain the respective second measurement of the first candidate cell in accordance with measuring the first reference signal; and
derive the respective first measurement associated with the first candidate cell in accordance with the respective second measurement, a transmission power of the UE, an offset, or any combination thereof.

5. The UE of claim 1, wherein, to obtain the respective first measurement and the respective second measurement, the one or more processors are individually or collectively operable to execute the code to cause the UE to:
receive, via the second communication link, a path loss reference signal from a first candidate cell of the set of candidate cells;
obtain a path loss of the second communication link in accordance with measuring the path loss reference signal; and
derive the respective first measurement associated with the first candidate cell in accordance with a transmission power of the UE and the path loss of the second communication link.

6. The UE of claim 1, wherein the control signaling further indicates a rule for combining the respective first measurement with the respective second measurement, and the one or more processors are individually or collectively further operable to execute the code to cause the UE to:
obtain, for each candidate cell, a respective composite measurement in accordance with a combination of the respective first measurement and the respective second measurement according to the rule, wherein an order of the subset of candidate cells in the mobility report is in accordance with the respective composite measurement of each candidate cell of the set of candidate cells.

7. The UE of claim 1, wherein the control signaling further indicates a first scaling factor associated with the first communication link and a second scaling factor associated with the second communication link, and the one or more processors are individually or collectively further operable to execute the code to cause the UE to:
obtain a respective adjusted first measurement in accordance with an application of the first scaling factor to each respective first measurement; and
obtain a respective adjusted second measurement in accordance with an application of the second scaling factor to each respective second measurement, wherein the respective adjusted first measurement of each candidate cell of the subset of candidate cells satisfies the quality metric, and wherein the respective adjusted second measurement of each candidate cell of the subset of candidate cells satisfies a second quality metric.

8. The UE of claim 1, wherein:
the control signaling further indicates a second quality metric associated with the second communication link for each candidate cell of the set of candidate cells, and
the respective second measurement of each candidate cell of the subset of candidate cells satisfies the second quality metric.

9. The UE of claim 1, wherein:
the control signaling further indicates a threshold quantity of candidate cells to be reported, and
a quantity of the subset of candidate cells satisfies the threshold quantity of candidate cells.

10. The UE of claim 1, wherein:
the first communication link comprises an uplink and the second communication link comprises a downlink; or
the first communication link comprises the downlink and the second communication link comprises the uplink.

11. A user equipment (UE), comprising:
one or more memories storing processor-executable code; and
one or more processors coupled with the one or more memories and individually or collectively operable to execute the code to cause the UE to:
receive control signaling indicating a first set of candidate cells and a second set of candidate cells associated with a mobility procedure at the UE, the first set of candidate cells being associated with a first communication link and the second set of candidate cells being associated with a second communication link, wherein the control signaling indicates a respective first priority for each candidate cell of the first set of candidate cells, and wherein the control signaling indicates a respective second priority for each candidate cell of the second set of candidate cells;
obtain a respective first measurement associated with the first communication link for the first set of candidate cells in accordance with the respective first priorities;
obtain a respective second measurement associated with the second communication link for the second set of candidate cells in accordance with the respective second priorities; and
transmit a mobility report that indicates a first subset of candidate cells of the first set of candidate cells and indicates a second subset of candidate cells of the second set of candidate cells, wherein the first subset of candidate cells are identified according to the respective first measurements, and wherein the second subset of candidate cells are identified according to the respective second measurements.

12. The UE of claim 11, wherein, to perform the mobility procedure, the one or more processors are individually or collectively operable to execute the code to cause the UE to:
communicate, for the first communication link, with a first candidate cell identified from the first subset of candidate cells in accordance with transmitting the mobility report; and
communicate, for the second communication link, with a second candidate cell identified from the second subset of candidate cells in accordance with transmitting the mobility report.

13. The UE of claim 11, wherein the control signaling comprises a list indicating the first set of candidate cells, and the one or more processors are individually or collectively further operable to execute the code to cause the UE to:
determine the respective first priorities for each candidate cell of the first set of candidate cells in accordance with an order of a respective index of each candidate cell of the first set of candidate cells within the list.

14. The UE of claim 11, wherein the control signaling comprises a list indicating the second set of candidate cells, and the one or more processors are individually or collectively further operable to execute the code to cause the UE to:
determine the respective second priorities for each candidate cell of the second set of candidate cells in accordance with an order of a respective index of each candidate cell of the second set of candidate cells within the list.

15. The UE of claim 11, wherein the one or more processors are individually or collectively operable to execute the code to cause the UE to:
determine the respective first priorities for each candidate cell of the first set of candidate cells in accordance with the respective identifiers.

16. The UE of claim 11, wherein the one or more processors are individually or collectively operable to execute the code to cause the UE to:
determine the respective second priorities for each candidate cell of the second set of candidate cells in accordance with the respective identifiers.

17. The UE of claim 11, wherein the control signaling indicates a first scaling factor associated with the first communication link and a second scaling factor associated with the second communication link, and the one or more processors are individually or collectively further operable to execute the code to cause the UE to:
obtain a respective adjusted first measurement in accordance with an application of the first scaling factor to each respective first measurement; and
obtain a respective adjusted second measurement in accordance with an application of the second scaling factor to each respective second measurement, wherein the respective adjusted first measurement of each candidate cell of the first subset of candidate cells satisfies a first quality metric, and wherein the respective adjusted second measurement of each candidate cell of the second subset of candidate cells satisfies a second quality metric.

18. The UE of claim 11, wherein the control signaling comprises a flag that indicates whether the UE is to implicitly determine the respective first priorities and implicitly determine the respective second priorities.

19. The UE of claim 11, wherein:
the first set of candidate cells and the second set of candidate cells are equivalent, and
the control signaling comprises a flag that indicates the respective first priorities and the respective second priorities are equivalent.

20. The UE of claim 11, wherein:
the control signaling further indicates a first quality metric associated with the first communication link and a second quality metric associated with the second communication link,
the respective first measurement for each candidate cell of the first subset of candidate cells satisfies the first quality metric, and
the respective second measurement for each candidate cell of the second subset of candidate cells satisfies the second quality metric.

21. A user equipment (UE), comprising:
one or more memories storing processor-executable code; and
one or more processors coupled with the one or more memories and individually or collectively operable to execute the code to cause the UE to:
receive control signaling that indicates a set of candidate cells associated with a mobility procedure at the UE, wherein the control signaling identifies a respective set of parameters associated with measurements of a first communication link for each candidate cell of the set of candidate cells;
obtain respective first measurements associated with the first communication link for each candidate cell of the set of candidate cells according to the respective sets of parameters;
obtain respective second measurements associated with a second communication link for each candidate cell of the set of candidate cells in accordance with the control signaling; and
transmit a mobility report that indicates a subset of candidate cells of the set of candidate cells and indicates at least the respective first measurements associated with one or more candidate cells of the subset of candidate cells.

22. The UE of claim 21, wherein, to obtain the respective first measurements and the respective second measurements, the one or more processors are individually or collectively operable to execute the code to cause the UE to:
receive, via the second communication link, a first reference signal from a first candidate cell of the set of candidate cells, wherein the first reference signal corresponds to a second reference signal associated with the first communication link;
obtain the respective second measurements of the first candidate cell in accordance with measuring the first reference signal; and
derive the respective first measurements associated with the first candidate cell in accordance with the respective second measurements, a transmission power of the UE, an offset, or any combination thereof, wherein the respective set of parameters associated with the first candidate cell comprises the offset.

23. The UE of claim 21, wherein, to obtain the respective first measurements and the respective second measurements, the one or more processors are individually or collectively operable to execute the code to cause the UE to:
receive, via the second communication link, a path loss reference signal from a first candidate cell of the set of candidate cells;
obtain a path loss of the second communication link in accordance with measuring the path loss reference signal; and
derive the respective first measurements associated with the first candidate cell in accordance with a transmission power of the UE and the path loss of the second communication link.

24. The UE of claim 21, wherein the control signaling further indicates a threshold quantity of candidate cells to be reported and a threshold quantity of beams per candidate cell to be reported, and wherein, to transmit the mobility report, the one or more processors are individually or collectively operable to execute the code to cause the UE to:
transmit, via the mobility report, an indication of a respective set of beams per candidate cell of the subset of candidate cells and an indication of a respective first measurement for each beam of the respective set of beams per candidate cell, wherein a quantity of the subset of candidate cells satisfies the threshold quantity of candidate cells, and wherein a quantity of beams of the respective set of beams per candidate cell satisfies the threshold quantity of beams.

25. The UE of claim 21, wherein the control signaling further indicates a first threshold quantity of candidate cells to be reported for the first communication link and a second threshold quantity of candidate cells to be reported for the second communication link, and wherein to transmit the mobility report, the one or more processors are individually or collectively operable to execute the code to cause the UE to:
transmit, via the mobility report, an indication of a respective set of beams per candidate cell of a first subset of candidate cells and an indication of a respective first measurement for each beam of the respective set of beams per candidate cell of the first subset of candidate cells, wherein a quantity of the first subset of candidate cells satisfies the first threshold quantity of candidate cells; and
transmit, via the mobility report, an indication of a respective set of beams per candidate cell of a second subset of candidate cells and an indication of a respective second measurement for each beam of the respective set of beams per candidate cell of the second subset of candidate cells, wherein a quantity of the second subset of candidate cells satisfies the second threshold quantity of candidate cells.

26. The UE of claim 21, wherein the control signaling further indicates a threshold quantity of candidate cells to be reported for both the first communication link and the second communication link, and wherein, to transmit the mobility report, the one or more processors are individually or collectively operable to execute the code to cause the UE to:
transmit, via the mobility report, an indication of a respective set of beams per candidate cell of the subset of candidate cells, an indication of a respective first measurement for each beam of the respective set of beams per candidate cell of the subset of candidate cells, and an indication of a respective second measurement for each beam of the respective set of beams per candidate cell of the subset of candidate cells, wherein a quantity of the subset of candidate cells satisfies the threshold quantity of candidate cells.

27. The UE of claim 21, wherein the control signaling further indicates a threshold quantity of candidate cells to be reported, and wherein to transmit the mobility report, the one or more processors are individually or collectively operable to execute the code to cause the UE to:
transmit, via the mobility report, an indication of a respective set of beams per candidate cell of the subset of candidate cells, an indication of a respective first measurement for each beam of a first subset of beams of each respective set of beams, and an indication of a respective second measurement for each beam of a second subset of beams of each respective set of beams, wherein a quantity of the subset of candidate cells satisfies the threshold quantity of candidate cells.

28. The UE of claim 21, wherein the control signaling further indicates a threshold quantity of candidate cells to be reported, an indication, per candidate cell, of a threshold quantity of beams to be reported, an indication, per candidate cell, of whether the respective first measurements are to be reported or the respective second measurements are to be reported, and wherein to transmit the mobility report, the one or more processors are individually or collectively operable to execute the code to cause the UE to:
transmit, via the mobility report and for a first candidate cell, a first set of beams and a respective first measurement for each beam of the first set of beams in accordance with the control signaling; and
transmit, via the mobility report and for a second candidate cell, a second set of beams and a respective second measurement for each beam of the second set of beams in accordance with the control signaling.

29. The UE of claim 21, wherein the respective set of parameters for each candidate cell of the set of candidate cells comprises a respective bandwidth, a respective transmission power, a respective pathloss, respective traffic load information, respective traffic utilization, respective quantity of active communication links, or any combination thereof.

30. A method for wireless communications by a user equipment (UE), comprising:
receiving control signaling that identifies a set of candidate cells associated with a mobility procedure at the UE, wherein the control signaling indicates a quality metric associated with a first communication link between the UE and the set of candidate cells;
obtaining, for one or more candidate cells of the set of candidate cells, a respective first measurement corresponding to the first communication link and a respective second measurement corresponding to a second communication link between the UE and the set of candidate cells; and
transmitting a mobility report that indicates a subset of candidate cells of the set of candidate cells in accordance with the obtaining, wherein the respective first measurement of each candidate cell of the subset of candidate cells satisfies the quality metric.
